(19) United States
(12) Patent Application Publication
(10) Pub. No.: US 2015/0142520 A1
(43) Pub. Date: May 21, 2015

(54) CROWD-BASED SENTIMENT INDICES

(71) Applicant: TruValue Labs, Inc., San Francisco, CA (US)

(72) Inventors: Gregory Bala, Morgan Hill, CA (US); Hendrik Bartel, San Francisco, CA (US); Phil Kim, South San Francisco, CA (US); Faithlyn A. Tulloch, San Francisco, CA (US); James P. Hawley, Oakland, CA (US); Tomislav Ribaric, Jursici (HR)

(21) Appl. No.: 14/503,277

(22) Filed: Sep. 30, 2014

Related U.S. Application Data
(60) Provisional application No. 62/008,268, filed on Jun. 5, 2014.
(60) Provisional application No. 61/887,309, filed on Oct. 4, 2013.

(51) Int. Cl. G06Q 30/02

(52) U.S. Cl. CPC G06Q 30/0203
USPC 705/7.32

(57) ABSTRACT

Systems and methods are provided for determining and displaying an indicator of crowd-based sentiments for an entity. Observers may provide feedback regarding various categories/metrics for the entity, which may be used to calculate a score representative of the crowd-based sentiment for the entity.

### CROSS-REFERENCE

This application claims the benefit of U.S. Provisional Application No. 61/887,309 filed Oct. 4, 2013 and U.S. Provisional Application 62/008,268 filed Jun. 5, 2014, which applications are incorporated herein by reference in their entirety.

### BACKGROUND OF THE INVENTION

Conventional methods for assessing and summarizing social sentiment over a selected area of interest typically involve specialized polling, or editorial summarization of news articles, or compendia of individual qualitative commentary, or similar approaches more loosely associated with source information regarding the area of interest. While these techniques capture some degree of social sentiment regarding an area of interest, they are often overly specialized, too imprecise, too indirect, inadvertently amplify input of statistical outliers, or are too infrequent.

Complementarily, conventional methods for ascribing numerical indices characterizing particular areas of interest, such as the financial performance of a publicly traded company, are usually self-generated by the area of interest and reflect only a narrow, standardized set of internal metrics often not capturing the true value of an entity within an area of interest, such as a company, as regarded by the set of all stakeholders or interested parties at large, usually external to the area of interest.

Thus, a need exists for improved systems and methods for providing a true value of an entity in the area of interest.

### SUMMARY OF THE INVENTION

It is apparent that a need exists for a technique whereby a numerical index, or plurality of indices, are generated to precisely reflect the aggregate sentiment of interested parties, stakeholders, experts and the like in regard to a particular area of interest and observation, however so specific or general. It is further apparent that a need exists to present informative items, related to an area of interest, in ways providing the most expedient information flow and most expedient gathering of sentiment feedback from observers. The invention is directed toward providing such techniques.

This invention relates to a method and system for the generation of a numerical index, or plurality of indices, characterizing a socially observable area of interest. The numerical index may be indicative of a value of an entity in the area of interest. Particularly, this invention relates to novel techniques for gathering quantitative and/or qualitative input from observers of an area of interest, attributed by observable informative items characterizing said area of interest, and transforming said input into a numerical index, or plurality of indices, reflecting the aggregate sentiment of the collection of participating observers of varying degrees of expertise and level of influence in said area of interest.

This invention is applicable in areas of interest such as evaluating the characteristics of corporate behavior and performance as traditionally and conventionally only characterized heretofore by standardized financial data and metrics. Furthermore, this invention is applicable in areas of interest that can be attributed by news articles consumable by an observant public, and where members of that public have varying degrees of expertise. The invention can be applicable to other areas of interest for polling audiences on certain characteristics, such as (but not limited to), of a product, sports team, individual athlete, celebrity, company, news, or other areas.

It is an object of the invention to provide a method and a system for gathering significant volumes of sentiment input from observant social participants. It is also an object of the invention to provide a method and a system for reducing the plurality of such sentiment input to a numerical index, or plurality of indices, that accurately and precisely characterize the sentiment in an area of interest or some facet therein. Another object of this invention is to provide a method to produce quantitative correlations between the sentiment indices it generates and the conventional or traditional metrics associated with a particular area of interest. A further object of this invention is to provide updates to the product numerical sentiment indices in real time and with high frequency. A specific object of this invention is to provide a method and a system for producing social sentiment indices, or “comprehensive crowd sentiment scores”, that characterize corporate behavior and performance based upon observations, upon known, related information sources, made by interested stakeholders of varying levels of expertise and influence. These and other objects of the invention will be apparent to those skilled in the art from the description that follows.

The methods and the systems described herein provide informative entities, in large quantity, such as news articles, expert opinions that had not been published before or attributed to a certain area of interest, or distillations or derivatives thereof, that yield current information about an area of interest to an observing public and enabling the observers to register feedback, over a continuum of time, upon one, many, or all the informative entities in a manner from which a quantitative characterization can be derived. An example of such manner is a moveable meter on a computer display, with the meter being associated with a single informative entity. This capability can be replicated for all informative entities for all areas of interest for all observers, and the feedback from each possible instance comprised of an informative entity in a particular area of interest being reviewed by a particular observer at a particular instant in time. In addition, the observers can be classified corresponding to their level of expertise or influence in the area of interest, and the quantitative characterization of their feedback can be weighted appropriately relative to such a classification scheme. All quantitative input then emanating from each of these instances may then be formulaically processed to yield an index, or a plurality of indices, that characterize the summary sentiment of the group of observers of each particular area of interest. Furthermore, the gathering of all observer feedback can be performed with the highest update frequency enabled by the information technology apparatus employed, an example being multiple digital computers on a high speed digital network, such as the Internet. In addition, the sentiment indices produced in this manner can be mathematically correlated with any conventional independent metrics possibly also existing in the area of interest to articulate the relationship between sentiment and conventional metrics.

When operated in the manner prescribed by the method stipulated herein, the method and system of this invention can enable the rapid and real-time gathering and summary feedback of observer sentiment information in a quantitative manner, and additionally enables observer interrogation of such summary sentiment information.

The method of this invention is particularly suited for areas of interest comprised of corporations with publicly observed qualitative behavior, including financial performance and metrics, such as share prices on a stock exchange.

The invention advances the art of providing capabilities to gather, summarize, and feed back observer sentiment information, over a given area of interest, or over a plurality of areas of interest, in a quantitative and concurrent, real time manner.

An aspect of the invention is directed to a method of providing a crowd sentiment-based index for an entity, comprising: displaying, on a visual display of a device, information about the entity; receiving, via the device, feedback from a user of the device providing an evaluation of the entity in a plurality of categories, wherein the categories include two or more of the following: leadership, innovation, environment, employee responsibility, and social responsibility; and calculating, with aid of a programmable processor, an overall entity value score based on the feedback from the user regarding the plurality of categories, thereby assessing social sentiment for the entity.

In some embodiments, the categories may include three or more of the following: leadership, innovation, environment, employee responsibility, and social responsibility. The method may further comprise displaying, on the visual display of the device, the overall entity value score with information about the entity. The information about the entity may include a news article about the entity. The feedback from the user may be provided via a user input region for each of the plurality of categories shown on the visual display with the information about the entity. The user input region may include a sliding scale, and the user may select a position along the sliding scale indicative of a numeral score for a respective category from the plurality of categories. The sliding scale may have a substantially circular shape.

The overall entity score may be calculated with aid of the programmable processor, further based on feedback from other users regarding the plurality of categories. A trend confidence in the overall entity score may be displayed with the overall entity score on the visual display of the device. The trend confidence may be displayed as a numerical confidence value calculated using a root mean square error technique. A crowd strength data quality may be displayed with the overall entity score on the visual display of the device. The crowd strength data quality may be displayed as a numerical quality value calculated with aid of the programmable processor, based on a start time and a stop time for consideration of feedback from the user and the other users between the start time and the stop time, and a freshness decay calculation of the feedback from the user and the other users used to calculate the overall entity score. The overall entity score may include a numerical value and a double gradient indicator having a first portion and a second portion, wherein the first portion shows a visual indication of an overall entity score based on the feedback from the user without considering feedback from the other users and the second portion shows a visual indication of an overall entity score based on feedback from the user and the other users.

Further aspects of the invention are directed to a method of providing a crowd sentiment-based index for an entity, comprising: displaying, on a visual display of a device, an overall entity value score for the entity calculated based on feedback from a plurality of users, each user providing an evaluation of the entity in a plurality of categories, wherein the categories include two or more of the following: leadership, innovation, environment, employee responsibility, and social responsibility; and displaying information identifying the entity on the visual display with the overall entity value score.

In some embodiments, the visual display of the device may show a plurality of entity identifiers and associated overall entity value scores for each of the entity identifiers. The visual display may further show a numerical amount of change in the value of the overall entity score for each of the entity identifiers. The visual display may show a ticker display that shows the plurality entity identifiers scrolling in a linear fashion along with the associated overall entity value scores and the numerical amount of change. The visual display of the device may show a news article about the entity including the information identifying the entity. The visual display may show a percentage change in the value of the overall entity score. The visual display may show category evaluations for the entity in the plurality of categories, wherein the category evaluations are based on feedback from the plurality of users.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the invention will be obtained by reference to the following detailed description that sets forth illustrative embodiments, in which the principles of the invention are utilized, and the accompanying drawings of which:

FIG. 1 is a schematic illustration of an embodiment of a method and system allowing a sentiment analytics engine to operate upon flows from a plurality of informative item source, a plurality of areas of interest, and a plurality of observers and contributors.

FIG. 2 is a flow diagram depicting the computation of temporally contiguous sentiment indices exhaustively over all areas of interest. In a preferable embodiment, the computation is carried out on standard computing devices known in the art.

FIG. 3a and FIG. 3b show examples of user interfaces through which an observer may select an option to provide sentiment feedback relating to an entity.

FIG. 4a and FIG. 4b show examples of user interfaces through which an observer may provide feedback in response to one or more questions.

FIG. 5a and FIG. 5b show examples of user interfaces showing a score indicative of the value of the entity.

FIG. 6 shows a display providing information about an entity's overall value score as well as scores for specific categories.

FIG. 7 shows a system for providing crowd-based sentiment indices in accordance with an embodiment of the invention.

FIG. 8 shows an example of a computing device in accordance with an embodiment of the invention.

FIG. 9 shows an example of a browser extension tool that may be used to collect user feedback about a web site.

FIG. 10 shows an example of a feedback region implemented using a browser extension tool.

FIG. 11 shows an example of a browser extension tool providing a link to a website of a system for providing crowd-based sentiment indices.

FIG. 12 shows an example of a user interface that displays live updates.

FIG. 13 shows an example of a voting widget.

FIG. 14 shows another view of a voting widget in accordance with an embodiment of the invention.

FIG. 15 provides an example of a ticker figure.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and methods for providing crowd-based sentiment indices. Various aspects of the invention described herein may be applied to any of the particular applications set forth below or for any other types of feedback. The invention may be applied as a standalone device, or as part of an integrated online valuation system. It shall be understood that different aspects of the invention can be appreciated individually, collectively, or in combination with each other.

Overview

The invention includes methods and systems for generating a numerical sentiment index, or a plurality of sentiment indices, representing the aggregate sentiment of a collection of contributing observers. The contributing observers may retain a range of expertise or influence in an area of interest, and may review informative items relating to said area of interest arising from a source, or plurality of sources.

In various embodiments, these methods and systems of the invention provide observers with feedback of the values of the sentiment index or indices associated with the area of interest, enabling further sentiment input by additional observers. The feedback provided to an observer may incorporate or aggregate values of the sentiment index or indices from other observers. This feedback looping process can then continue indefinitely and with updates at high temporal frequency.

Furthermore, in various embodiments, these methods and systems of the invention provide observers with a flow of the latest informative items, most recently available from their sources, which can be contemplated for additional sentiment input.

Methods and systems of the invention are preferably designed to provide observers with precise numerical representations of the most current possible sentiment associated with an area of interest, in addition to a temporal history of such a numerical representation over arbitrary, selectable ranges of time.

The various functions and methods described herein are preferably embodied within software modules executed by one or more devices possessing general purpose computing capabilities, including, but not limited to, general purpose computers, mobile “smart” phones, tablet computers, or any device possessing a Von Neumann computer architecture. A preferable embodiment also includes computing devices presenting output on visual display units, with a further preference being those with input touch capabilities. In certain preferable cases, some of the various functions and methods described herein can be embodied within hardware, firmware, or a combination or sub-combination of software, hardware, and firmware. Further examples of device or hardware characteristics are described elsewhere herein.

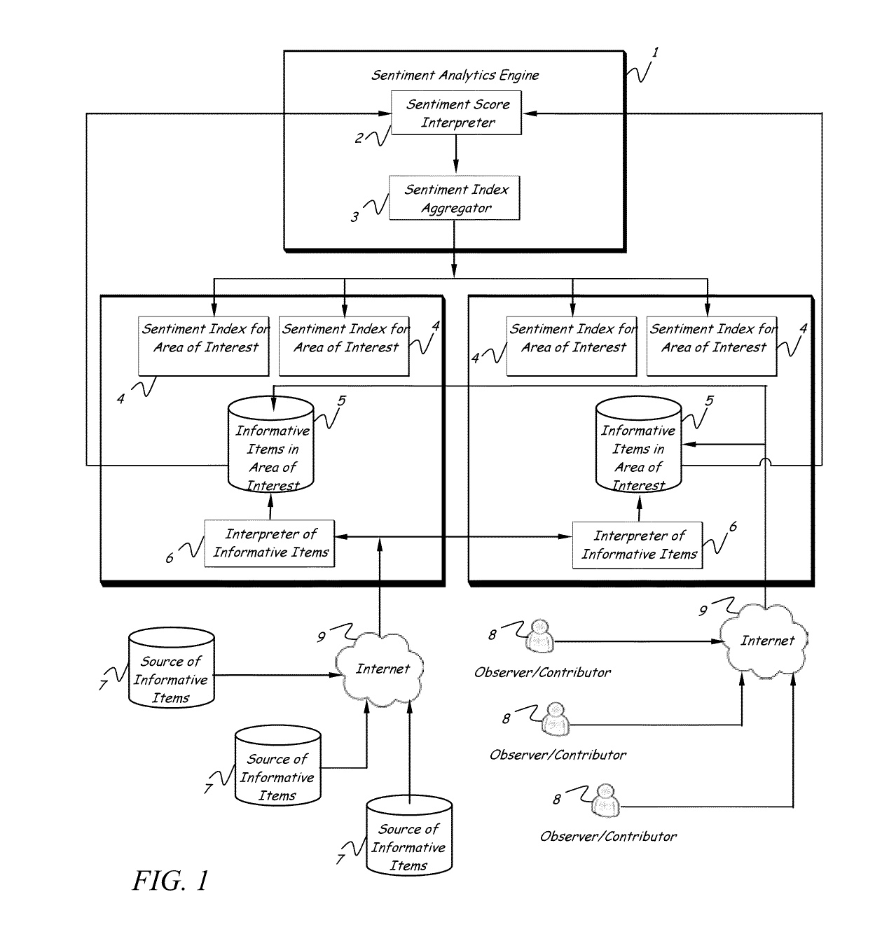

FIG. 1 illustrates a preferable embodiment of the invention comprising a sentiment analytic engine 1, which comprises a sentiment score interpreter 2 that gathers, quantifies, and measures sentiment feedback information corresponding to an informative item in an area of interest 5. The sentiment analytic engine 1 may further comprise a sentiment index aggregator 3 that distributes, for each area of interest, a sentiment index, or plurality of sentiment indices 4. The sentiment index or indices may be mathematically or algorithmically derived from sentiment score information quantified and measured by the sentiment score interpreter 2 for each area of interest. The sentiment score information may be associated with an informative item, being within a plurality of such informative items 5, each associated with sentiment input contributed by an observer, or plurality of observers 8. In some embodiments, the areas of interest may relate to different categories or metrics relating to an entity. The areas of interest may relate to different ways of measuring value, finances, performance, image, publicity, responsibility, or activity of an entity. The areas of interest may be of interest to an investor who may want to invest in an entity, purchase or acquire products and services from the entity, or provide products and services to the entity. The areas of interest may be known as an ESG framework and may typically measure Environmental, Social and Corporate Governance aspects of a company.

FIG. 1 further illustrates a preferable embodiment of the invention additionally comprising an interpreter of informative items 6, which collects, through search techniques known in the art, informative items from available sources 7 relating to a given area of interest. In a preferable embodiment of the invention, the interpreter of informative items algorithmically summarizes the informative items, using summarization algorithms known in the art, to produce compact representations of the original informative items sufficient for ease of consumption by observers and contributors 8. The interpreter of informative items 6 preferably has an additional capability to generate a conventional sentiment score using sentiment computation algorithms known in the art. An available source of informative items 7 may be, for example, a standard known news or analysis source available to the public as a service, providing information items as digital data through the Internet 9 to consumers of such informative items.

In addition to employing summarization algorithms known in the art, to produce compact representations of the original informative items sufficient for ease of consumption by observers and contributors, an algorithm carrying out any or all the steps below can be alternatively employed to produce a compact representation:
Obtain source text and parse into separate collections of words and sentences.
Construct an additional separate collection of “commonly used” words to not be included as substantively significant. This collection can include parts of speech such as direct and indirect articles, non-nouns, and other preset words identified as not significant to the area of interest.
Construct an additional separation collection of words pertinent to the area of interest. (As an example, if the area of interest is a company, the name of the company would be included in the collection.) For each word in the collection, assign a relative numerical weight.
Traverse the source text and count the occurrences of all words not in the “commonly used” collection.
Traverse the collection of sentences and ascribe a weight to each as an increasing function of:
   The sum of the counts of occurrences of non “common use” words in the sentence within the overall source text.
   The sum of the weights of words pertinent to the area of interest.
Sort the weighted sentences by weight, highest to lowest.
Display to consumers the sentences from the sorted list do any desirable depth (For example, first five sentences), and interpret this result as a summarization of the source material.

The method of providing compact representations of the original information may be used by way of example only and is not limiting.

Sentiment Acquisition Methods

A preferable embodiment of the invention provides capabilities for each observer or contributor 8 to efficiently inspect multiple informative items in an area of interest 5. A preferable mode of presenting a plurality of information items 5 may include augmenting conventional methods of presenting multiple information items simultaneously known in the art, such as computer display “windows”, “tiles”, and the like, with movement and content selection algorithms enabling rapid consumption and feedback acquisition. The multiple informational items simultaneously displayed may relate to a single entity or multiple entities.

A preferable embodiment of such algorithms driving the presentation of information items include controlling the duration of time an item is presented proportional to the amount of sentiment feedback upon it, relative to that of other information items being presented.

Similarly, a preferable embodiment of algorithms driving the presentation of information items include controlling the proportion of display area occupied by the information items with a positively correlated proportion of sentiment feedback relative to that of other information items being presented.

Another preferable embodiment of a display control algorithm enables information item display duration and display proportion to be controlled by the incident reference counts upon each information item by other information items.

A further preferable embodiment of the information item display control algorithm displays information items in visual clusters as they relate to particular areas of interest.

An additional preferable embodiment of a display control algorithm combines the above techniques with preset weights of influence.

An additional preferable embodiment of the invention to acquire sentiment measurements employs natural language processing (NLP) algorithms known presently in the art which detect superlative (positive or negative) sentiment related to attributes of entities described in natural language, textual or audio. The algorithm may be steered, as known in the art, with keywords relating to the particular areas of interest. The sentiment output is then made mathematically comparable with the observer-driven sentiment metrics through known mathematical normalization and scaling techniques.

Score Interpretation Methods

In reference to FIG. 1, a preferable embodiment of the sentiment score interpreter 2, delivers capabilities to tabulate, in preparation for use by the sentiment index aggregator 3, numerical sentiment score values associated with a particular informative item in a particular area of interest 5, provided by a particular contributor 8.

An additional preferable embodiment of the sentiment score interpreter 2, delivers capabilities to algorithmically generate, in preparation for use by the sentiment index aggregator 3, additional numerical sentiment scores correlated with the known sentiment of the author of an information item being examined by any or all observers and contributors.

An additional preferable embodiment of the sentiment score interpreter 2, delivers capabilities to algorithmically generate, in preparation for use by the sentiment index aggregator 3, additional numerical sentiment scores generated by applying known automated sentiment scoring algorithms to textual feedback items, such as “blog comments”, associated with each informative item being examined by any or all observers and contributors.

An additional preferable embodiment of the sentiment score interpreter 2, delivers capabilities to algorithmically generate, in preparation for use by the sentiment index aggregator 3, additional numerical sentiment scores generated by applying known automated sentiment scoring algorithms to “social media” content relative to the area of interest associated with each informative item being examined by any or all observers and contributors. A skilled artisan can appreciate the use of “social media” to obtain sentiment information.

Sentiment Index Generation Methods

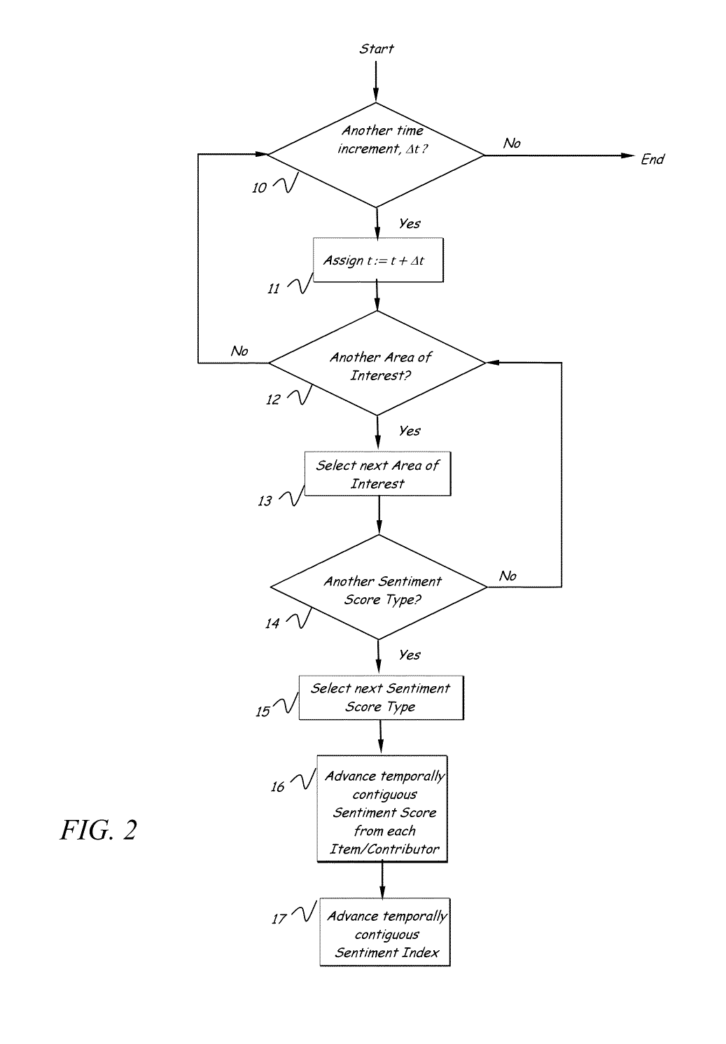

With reference to FIG. 1, a preferable embodiment of the sentiment index aggregator 3, delivers capabilities to algorithmically generate, as described below, a sentiment index, or plurality of sentiment indices, associated with each area of interest 4, upon gathering input from the sentiment score interpreter 2. With reference to FIG. 2, a preferable method generates sentiment indices for each area of interest at regular, irregular, or arbitrary time increments 10, as desired by the consumer of the sentiment index, or plurality thereof. A skilled artisan can appreciate that a mark of time derived by arithmetically summing a prior mark of time with the new increment can be contemplated as an update time mark 11 for the sentiment index, or plurality of sentiment indices to be derived.

In a preferable embodiment, all areas of interest can be represented and maintained as a collection of computational data resident in the storage subsystems of a computing device known in the art. A skilled artisan can then appreciate the process of computationally examining each area of interest sequentially 13 and the capability to repeat the examination of the sequence an arbitrary number of times 12, preferably indefinite. A preferable embodiment further allows for the insertion or deletion of unique areas of interest into the collection.

In a preferable embodiment, all sentiment score types related to an area of interest can be represented and maintained as a collection of computational data resident in the storage subsystems of a computing device known in the art. A skilled artisan can then appreciate the process of computationally examining each sentiment score type sequentially 15 and the capability to repeat the examination of the sequence an arbitrary number of times 14. In some instances, the examination may be repeated until a pre-condition is met. In some instances, the examination may be repeated indefinitely. A preferable embodiment may further allow for the insertion or deletion of unique sentiment score types into the collection, corresponding to a given area of interest.

In a preferable embodiment of the invention, for a sentiment score type under examination, as determined by the sentiment score type examination selection process 15, within an area of interest under examination, as determined by the area of interest examination selection process 13, the current numerical value for the sentiment score is acquired from the sentiment score interpreter 2, in reference back to FIG. 1, for a particular informative item 5 scored by a particular contributor 8. Preferably, the sentiment score numerical value is associated with the current time mark determined in the time mark incrementing process 11. A skilled artisan can appreciate the preferable recording of the association of the numerical sentiment score value with the current time mark in the digital storage media of a computing device, as a preferable method for such recording. A preferable method for then generating the temporally contiguous sentiment index, yielding a numerical sentiment index value at an arbitrary time mark, at present or at a past time, aggregated across all informative items associated with a particular area of interest, with associated sentiment scores provided by a contributor, or plurality of contributors, carried out by the sentiment index aggregator process 3 is as follows. In one embodiment, this step of advancing the temporally contiguous sentiment index 17, for current or future access by consumers of the value yielded, is generated according to the following method. However, skilled artisans will understand from the teachings herein that other methods for computing such a temporally contiguous numerical sequence of values can be used.

A particular contributing observer 8 that provides a sentiment score can be labeled u for this preferable method description. Similarly, a particular informative item in an area of interest 5 can be labeled i for this preferable method description. Additionally, the time mark generated in step 11 can be labeled tᵤᵢ for this preferable method description. For this preferable method description, the sentiment score value provided by the contributor u, through the sentiment score interpreter 2, associated with a particular informative item i, at a particular time t can be labeled R(t)(u)(i). For the purposes of this preferable method description, it will apply to a particular sentiment score type in a particular area of interest, as the skilled artisan can appreciate that it can be applied to each sentiment score type within each area of interest with no change to the method itself. R(t)(u)(i) can be considered as a function of three variables, contiguous in time t, and discrete in both u and i. R may be a sentiment score given by an observer (e.g., may be one of a plurality of dimension values). A skilled artisan can appreciate these mathematical interpretations. The value of the function at any time t is the sentiment score, provided by observer u on informative item i is defined, in the mathematical terminology know in the art as a “step” function, and with the value of the sentiment score set at the most recently updated time tᵤᵢ. This value persists until the next update time tᵤᵢ. For all time prior to the first update time tᵤᵢ the function is not defined mathematically. For this preferable method description, the sentiment index value can be labeled S(t), which is the objective of step 17. In this preferable embodiment, S(t) is computed by ranging over all u and all i, multiplying each value of R(t)(u)(i) found by a weight associated with the particular observer u and particular information item i, summing these products together and then dividing the completed sum by the sum of all the weights. The skilled artisan can appreciate that the weights can be pre-recorded in digital storage media associated with a computing device and extracted for this calculation. In a preferable embodiment of this invention, the weights can be pre-correlated with the significance of the observer and the significance of the information item.

A further preferable embodiment generates a summary sentiment index by mathematically combining a plurality of sentiment indices related to an area of interest 4 applying a mathematical function that maps multiple scalar values into a single scalar value. A preferable embodiment of such a function is an arithmetic mean. A further preferable embodiment of such a function is a weighted arithmetic mean, with weights set correlated to the significance of a particular contributing sentiment index to the overall summary thusly computed. A preferable embodiment in selecting the plurality of sentiment indices related to an area of interest for summarization would be those indices corresponding to areas of interest subordinate to a particular major area of interest. Examples of this arrangement include scenarios where the major area of interest represents a publicly traded corporation and the subordinate areas of interest represent facets of corporate governance and behavior, such as leadership, employee relations, innovation, supplier or “ecosystem” relations, environmental stewardship, and customer relations.

An alternative embodiment for generating sentiment indices that unifies and weighs the various inputs is described below:

### Given:

$$v ( {u}_{i , g} , {d}_{n} , {c}_{j , k} , s , {t}_{m} ) ≡ vote value from the {i}^{th} observer {u}_{i , g} of the {g}^{th} classification group , in the {n}^{th} category dimension {d}_{n} , for the {j}^{th} area of interest {c}_{j , k} of the {k}^{th} area of interest group , observing the {s}^{th} information source , at the {m}^{th} past time stamp {t}_{m} ( measured in whole and fractional days ) , ∀ i , g , n , j , k , m$$

$${I}_{g} ≡ number of observers in the {g}^{th} observer classification group$$

$${I}_{g} ( {d}_{n} , {c}_{j , k} ) ≡ number of observers in the {g}^{th} observer classification group who have ever cast a vote value in the {n}^{th} category dimension {d}_{n} , for the {j}^{th} area of interest {c}_{j , k} of the {k}^{th} area of interest group$$

$$G ≡ number of observer classification groups$$

$$N ≡ number of category dimensions$$

$${J}_{k} ≡ number of areas of interest in the {k}^{th} area of interest group$$

$$K ≡ number of area of interest groups$$

$$M ≡ number of timestamp events$$

$${v}_{0} ≡ vote value considered neutral - below which is considered negative , above which positive$$

$${w}_{g} ≡ weight of {g}^{th} observer classification group , ∀ g$$

$${y}_{n , k} ≡ within {n}^{th} category dimension , weight of {k}^{th} industry , ∀ n , k$$

$${z}_{s} ≡ normalized weight of {s}^{th} information source , ∀ s$$

$$r ≡ average daily rate of information decay$$

$${D}_{a} ≡ {a}^{th} day within a contiguous sequence of days spanning all {t}_{m} at which any vote was made , measured on scale common with the {t}_{m}$$

$$T ( {D}_{a} , {d}_{n} , {c}_{j , k} ) ≡ set of all {t}_{m} at which votes in the {n}^{th} category dimension {d}_{n} , for the {j}^{th} company {c}_{j , k} of the {k}^{th} industry , contained within day {D}_{a}$$

$$\vert T ( {D}_{a} , {d}_{n} , {c}_{j , k} ) \vert ≡ size of set T ( {D}_{a} , {d}_{n} , {c}_{j , k} ) ≡ daily vote volume in the {n}^{th} category dimension {d}_{n} , for the {j}^{th} area of interest {c}_{j , k} of the {k}^{th} area of interest group$$

$${D}_{a} ( {t}_{m} ) ≡ day {D}_{a} containing {t}_{m}$$

$${V}_{n} ( {c}_{j , k} , {t}_{m} ) ≡ \vert T ( {D}_{a} , ( {t}_{m} ) , {d}_{n} , {c}_{j , k} ) \vert ≡ daily vote volume in the {n}^{th} category dimension {d}_{n} , for the {j}^{th} area of interest {c}_{j , k} of the {k}^{th} area of interest group , on day containing {t}_{m}$$

$$f ( t , {t}_{m} ) ≡ {( 1 - r )}^{t - {t}_{m}} ≡ freshness factor of time {t}_{m} relative to time t \geq {t}_{m}$$

$$f ( t , {D}_{a} ) ≡ {( 1 - r )}^{t - {D}_{a}} ≡ freshness factor of day {D}_{a} relative to time t \geq {t}_{m}$$

### Compute:

$${TS}_{i , g , n} ( {c}_{j , k} , t ) ≡ sentiment score from the {i}^{th} observer {u}_{i , g} of the {g}^{th} classification group , in {n}^{th} category dimension for the {j}^{th} area of interest {c}_{j , k} of the {k}^{th} area of interest group at time t ≡ {\sum }_{m = 1}^{M} [ ( f ( t , {D}_{a} ( {t}_{m} ) ) {V}_{n} ( {c}_{j , k} , {t}_{m} ) ) f ( t , {t}_{m} ) {z}_{s} ( v ( {u}_{i , g} , {d}_{n} , {c}_{j , k} , s , {t}_{m} ) - {v}_{0} ) ] / {\sum }_{m = 1}^{M} [ ( f ( t , {D}_{a} ( {t}_{m} ) ) {V}_{n} ( {c}_{j , k} , {t}_{m} ) ) f ( t , {t}_{m} ) ] ∀ i , g , n , j , k = average of {i}^{th} observer vote values , relative to the neutrality origin {v}_{0} in {n}^{th} category dimension for area of interest {c}_{j , k} , weighted by freshness , accompanying companion voting volume , and information source weight , \\ {TS}_{g , n} ( {c}_{j , k} , t ) ≡ sentiment score from the {g}^{th} observer classification group , in {n}^{th} category dimension for the {j}^{th} area of interest {c}_{j , k} of the {k}^{th} area of interest group at time t ≡ {\sum }_{i = 1}^{I} [ {TS}_{i , g , n} ( {c}_{j , k} , t ) ] / {I}_{g} ( {d}_{n} , {c}_{j , k} ) ∀ g , n , j , k = average in the {g}^{th} observer classification group of individual observer sentiment scores in {n}^{th} category dimension for area of interest {c}_{j , k}$$

$${TS}_{n} ( {c}_{j , k} , t ) ≡ sentiment score in {n}^{th} category dimension for the {j}^{th} area of interest {c}_{j , k} of the {k}^{th} area of interest group at time t ≡ {\sum }_{g = 1}^{G} [ {w}_{g} {TS}_{g , n} ( {c}_{j , k} , t ) ] / {\sum }_{g = 1}^{G} [ {w}_{g} ] ∀ n , j , k = average sentiment scores over all observer classification groups , weighted per each such group$$

$${TV}_{i , g} ( {c}_{j , k} , t ) ≡ overall sentiment value from the {i}^{th} observer {u}_{i , g} of the {g}^{th} classification group , for the {j}^{th} area of interest {c}_{j , k} of the {k}^{th} area of interest group at time t ≡ {\sum }_{n = 1}^{N} [ {y}_{n , k} {TS}_{i , g , n} ( {c}_{j , k} , t ) ] / {\sum }_{n = 1}^{N} [ {y}_{n , k} ] ∀ i , g , j , k = average individual sentiment scores over all category dimensions , weighted per category and area of interest group$$

$${TV}_{g} ( {c}_{j , k} , t ) ≡ overall sentiment value from the {g}^{th} observer classification group , for the {j}^{th} area of interest {c}_{j , k} of the {k}^{th} area of interest group at time t ≡ {\sum }_{n = 1}^{N} [ {y}_{n , k} {TS}_{g , n} ( {c}_{j , k} , t ) ] / {\sum }_{n = 1}^{N} [ {y}_{n , k} ] ∀ g , j , k = average observer category group sentiment scores over all category dimensions , weighted per category and area of interest group$$

$$TV ( {c}_{j , k} , t ) ≡ overall sentiment value for the {j}^{th} area of interest {c}_{j , k} of the {k}^{th} area of interest group at time t ≡ {\sum }_{n = 1}^{N} [ {y}_{n , k} {TS}_{n} ( {c}_{j , k} , t ) ] / {\sum }_{n = 1}^{N} [ {y}_{n , k} ] ∀ j , k = average sentiment scores over all category dimensions , weighted per category and area of interest group$$

Sentiment Index Correlation Methods

A preferable embodiment of the invention enables the consumer of sentiment indices, generated within the capabilities of the invention, to additionally consume information characterizing the correlation of the generated sentiment indices with known, published indices in the area of interest. A skilled artisan can appreciate the use of known mathematical correlation techniques for determining correlation metrics between the sentiment indices generated by embodiments of the invention and known indices characterizing the area of interest.

Temporal Metrics and Instrumentation

A preferable embodiment of the invention enables the consumer of sentiment indices, generated within the capabilities of the invention, to additionally consume information articulating the behavior of the indices over time as described below.

Moving Averages

To depict aggregate temporal behavior of the index over selectable windows of time, a preferable embodiment of the invention enables the consumer to view a curve representing the moving average of the index over time. A skilled artisan can appreciate the use of known mathematical techniques for computing the simple moving average, the cumulative moving average, the weighted moving average, and the exponential moving average. Any or all these are applicable in displaying moving average behavior of a sentiment index to a consumer in conjunction with the temporal behavior of the sentiment index itself.

Trends

To further depict aggregate temporal behavior of the index over selectable windows of time, a preferable embodiment of the invention enables the consumer to view a curve representing a mathematically fit trend. A skilled artisan can appreciate the use of known mathematical techniques for computing polynomial fit curves of selectable degree, periodic fit curves, and exponential fit curves. Any or all these are applicable in displaying trending behavior of a sentiment index to a consumer in conjunction with the temporal behavior of the sentiment index itself.

Trend Confidence Metric

For a given trend as described above, to provide an indication that the trend will continue into the future with its current parameters, enabling predictability, an embodiment of the invention enables the consumer to obtain a figure of merit indicating the confidence that the trend will continue. Such an indicator may make use of metrics known in the art as goodness of fit. A confidence figure can be computed as follows:
The root mean square error (RMSE) over a time range of interest between the actual sentiment index time series data and a trend curve may be computed.
The resultant RMSE can then be embedded within other formulae to represent it in a desired scale and amplification suitable for graphical display in conjunction with the sentiment index itself. This computation can then be computed over the entire range of interest to trace a curve of confidence to be displayed in conjunction with the sentiment index itself. An example of such a formula is as follows:

Trend Confidence=A×(B−C×RMSE/100−D)
where A=10
where B=1
where C=10
where D=0.9

In alternate implementations, other numerical values may be provided for A, B, C, and/or D.

In a further refinement of this metric, within an alternative embodiment of the invention, a predictive period of time, dt, may be selected by the consumer, in addition to a prior fit period of time T. A trend calculation can then be performed as described above for a selected fit type to generate the fit parameters that can then extend the curve beyond the fit period T by the selected predictive period dt. Error calculations may then be performed between the predicted curve and the actual data over the interval dt and the confidence figure may be computed for that range, rather than the fit range as described above.

Sentiment Index Correlation and Trend Applicability to Forecasting

To provide the ability to forecast an index characterizing the area of interest, a correlation calculation between the sentiment index and the index characterizing the area of interest can be performed and extrapolated to estimate a forecasted value of the index characterizing the area of interest. A skilled artisan can appreciate the use of known mathematical techniques for computing correlated trends that are extrapolatable into the future to obtain estimates of future values of one or all of the correlated variables. A preferable embodiment of conducting such a calculation is the use of neural networking algorithms, using time sequences of multiple indices to train the network and then applying the trained network to forecast future values of the indices.

Observer Concentration Metric

To provide an assessment of the crowd strength data quality of a particular sentiment index, an embodiment of the invention enables the consumer to query a metric indicating the concentration of observers of various observer classes convolved with the recentness or “freshness” of the observer sentiment. One or more of the following steps may be implemented to compute such a metric:
Receive the start and stop date/times for the range of interest as input from the consumer.
Retrieve weighting factors to be applied to each class of observer from an internal database. There may be a one-to-one mapping between weights and observer classes.
Retrieve the freshness decay rate from the database. This may be a number that will exponentially decay the shelf life of a particular observation over time using a formula below, similar to that of compounded interest (but in reverse). Thus, a more recent observation may be accorded greater weight.
Retrieve the freshness de-compounding period from persistent data storage. In embodiments of the invention where observable informative items are news items, an exemplary decompounding period would be one day, as that is the nominal news cycle that would suggest a canonical refresh period. Any other time periods may be provided for decompounding periods, such as 1 year, 1 quarter, 1 month, several weeks, 1 week, several days, 1 day, several hours, 1 hour, 30 minutes, or 10 minutes.
From the start date/time to the stop date/time, compute a weighted sum of all counts of observations, within each de-compounding period distributed between the start date/time and the stop date/time, over all observer classes, each with its associated weight. The result of this step may be a partial sum of weighted components for each de-compounding period subdividing the time range between the start date/time and the stop date/time.
Apply to each of those partial sums an additional freshness factor weight. The freshness factor is computed as f=(1−r)̂n, where r may be the freshness decay rate and n may be the number of freshness de-compounding periods within the time interval between the time of the observation and the stop date/time. The result of this step will be partial sums multiplied by their appropriate freshness factor.
Sum all such partial sums to obtain the current sum value for entity of interest.
Retrieve the global maximum of this same sum (obtained by applying this same weighted sum method on all entities and storing the maximum value found).
Divide the sum by the global maximum to obtain the normalized Observer Concentration Metric and express as a percentage.
Compute this quantity for points in time between the start date/time and the stop date/time at a desired time resolution and plot as a curve accompanying the sentiment index itself

To refine the value of the freshness decay rate, an algorithm may be employed that may sample the pool of observation data to characterize a canonical rate of change as follows:
At a sampling rate equal to the freshness de-compounding period, sample all observations determine the average percent change of sentiment value between each sample and the next consecutive one in the time series.
Set this average value as the freshness decay rate.

Long Term Sentiment Value Accumulation Metric

To reflect the cumulative effects of sentiment over time, a consumer may query a metric indicating the sustainability of the sentiment level over extended periods of time. A preferable embodiment of the invention may implement the following to compute such a metric:
The metric for an entity can increase its value in a period of time, T, by some fixed metric maximum for that period of time, M, if it maintains a constant maximum sentiment value, m, for each sampling period, dt, over the period of time. If the sentiment value, v, varies below this maximum for intervals within the period of time, then the accumulated metric will be lower at the close of the period. In addition, if the sentiment value varies below a set minimum, 1, then the contribution to the metric at that sampling point will be negative. The contribution to the metric for a sampling period k may be computed as: c(k)=1+M*dt/T*(v−1)/(m−1). The metric L(k+1) for sample k+1 may then be computed recursively as L(k+1)=c(k)*L(k). Over time, value can accumulate in a compounded way as it would in a financial asset.

Trend Alerts

To provide an indication that a trend may be changing, or if a trend is deviating from a trend of another index associated with an entity, a consumer may obtain alerts when these triggers are detected. A preferable embodiment of calculating the conditions for such triggers is as follows:
Parameters and Variables:
   T=time window for examining possible trend change
   dV=change slope of a sentiment index linear segment fit
   dS=change slope of a comparable index linear segment fit
   VdS=AbsoluteValue(dV−dS)
   adV=threshold of dTV above which an alert will be signaled
   aVdS=threshold of TVdS above which an alert will be signaled
For the sentiment index curve, a “tail fit” may be applied per the subfunction below to obtain dV
If (dV>=adV)=>an alert may be issued suggesting the sentiment index may be breaking into a new trend
For the comparable index curve, a “tail fit” may be applied per the subfunction below to obtain dS
Compute VdS
If (VdS>=aVdS)=>an alert may be issued suggesting the sentiment index may be leading the comparable index in a new direction, up or down
   Subfunction for computing “tail fit” to a curve:
Given time window T, collect all points on the curve from present time−T to present time
Conduct a linear regression fit of those points (polynomial of degree 1 or just a linear fit—either one works)
Produce the linear parameters of the fit, including the slope

Volatility Metrics

To provide an assessment of the time series volatility of a particular sentiment index, an embodiment of the invention enables the consumer to query a metric indicating a relative magnitude of index variability over time. An embodiment of the invention can include one or more of the following steps to compute a volatility metric:
Collect a time-ordered series of nodes consisting of value pairs consisting of a time stamp measured to any precision and a corresponding value, which can be a sentiment index. The range of time can be arbitrary (e.g. within one week, one month, one year, etc.)
Apply a fractal dimension determination algorithm known in the art to a time-ordered series of time value pair nodes.
Scale to a preferable or predetermined magnitude range a fractal dimension value measured upon a time-ordered series of time-value pair nodes.
Interpret a scaled fractal dimension value measured upon a time-ordered series of time-value pair nodes as a volatility index for the values in the nodes, which can be sentiment index values.

Another embodiment of the invention can include one or more of the following steps to compute a volatility metric:
Collect a time-ordered series nodes consisting of value pairs consisting of a time stamp measured to any precision and a corresponding value, which can be a sentiment index.
Measure a length metric of the polygon or curve traced out by a time-ordered series of time value pair nodes.
Compute the two-dimensional bounding box, known in the art, of a time-ordered series of time value pair nodes.
Compute the diagonal of a two-dimensional bounding box, known in the art, of a time-ordered series of time value pair nodes.
Divide the a length metric of the polygon or curve traced out by a time-ordered series of time value pair nodes by the diagonal of a two-dimensional bounding box, of a time-ordered series of time value pair node.
Scale to a preferable or predetermined magnitude range the quotient obtained by dividing the a length metric of the polygon or curve traced out by a time-ordered series of time value pair nodes by the diagonal of a two-dimensional bounding box, known in the art, of a time-ordered series of time value pair nodes and interpret as a volatility index for the values in the nodes, which can be sentiment index values.

Volatility Metric Correlations

To provide an assessment of the relationship of a time series volatility of a particular sentiment index and a published time series indicating volatility obtained by means outside the scope of this invention, yet of additional interest to observers, an embodiment of the invention may enable the consumer to query correlation metrics indicating a strength of relationships between the volatility metrics computed by the invention and external indices of interest. Correlations of this kind can be obtained using statistical correlation methods known in the art and providing the results of such analyses to the consumer. An embodiment of the invention can correlate stock price action beta metrics with volatility indices computed by the invention.

User Interface

A user interface may be provided through which observer feedback may be solicited regarding an entity. The observer may also be able to view a score indicative of the value of the entity. The entity may be a company, corporation, partnership, venture, individual, organization, or business. In one example, the entity may be a publicly traded company. Alternatively, the entity may be a private company. The score may be a numerical value representative of the value of the company. Value may refer to crowd-based sentiment, performance, financial value, or any other index.

In some implementations, entity articles may be displayed on a user interface subject to observer preferences, the significance of the article, or related entity. The entity articles may be provided by the entity, or may be about the entity.

Presentation variations on a user interface may relate to the speed/cycle of an update, size of display area dedicated to the information (e.g., the size), highlighting, and/or other visual cues.

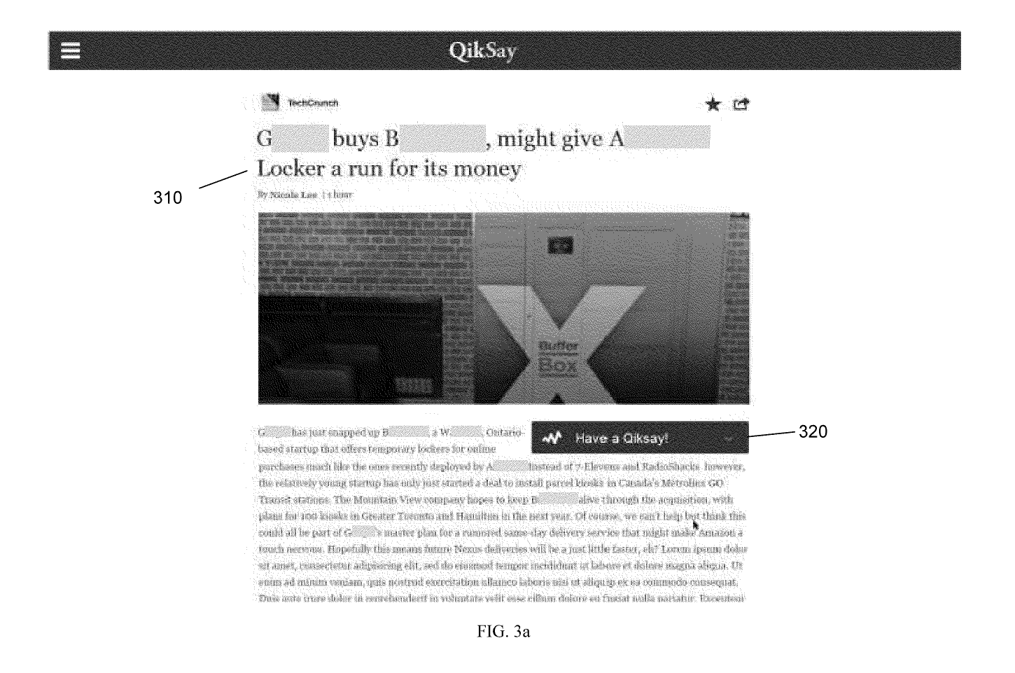

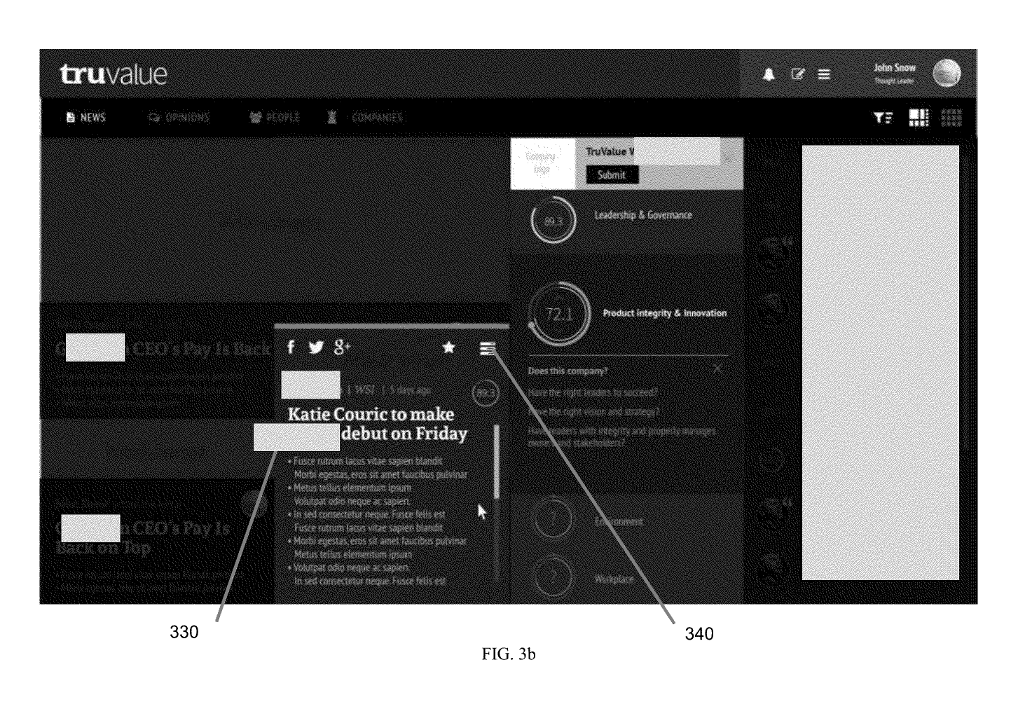

FIG. 3a and FIG. 3b show examples of user interfaces through which an observer may select an option to provide sentiment feedback relating to an entity, in accordance with an embodiment of the invention. In some embodiments, the user interface may show information 310, 330 about the entity. For example, the information may be an article, news, financial tracker, tweet, posting, blog, or any other information relating to the entity.

In some embodiments, the user interface may also include a region 320, 340 through which the observer may select the option to provide feedback. The feedback region may be implemented as a widget, may be displayed on a browser or application, or may be implemented in any other fashion. In some instances, the feedback region may be presented as a button, pop-up, drop-down menu, pane, or any other user interactive region.

Information about the entity 310, 330 and the region through which the observer may provide feedback 320, 340 may be simultaneously displayed. The user may provide feedback about the displayed entity via the region.

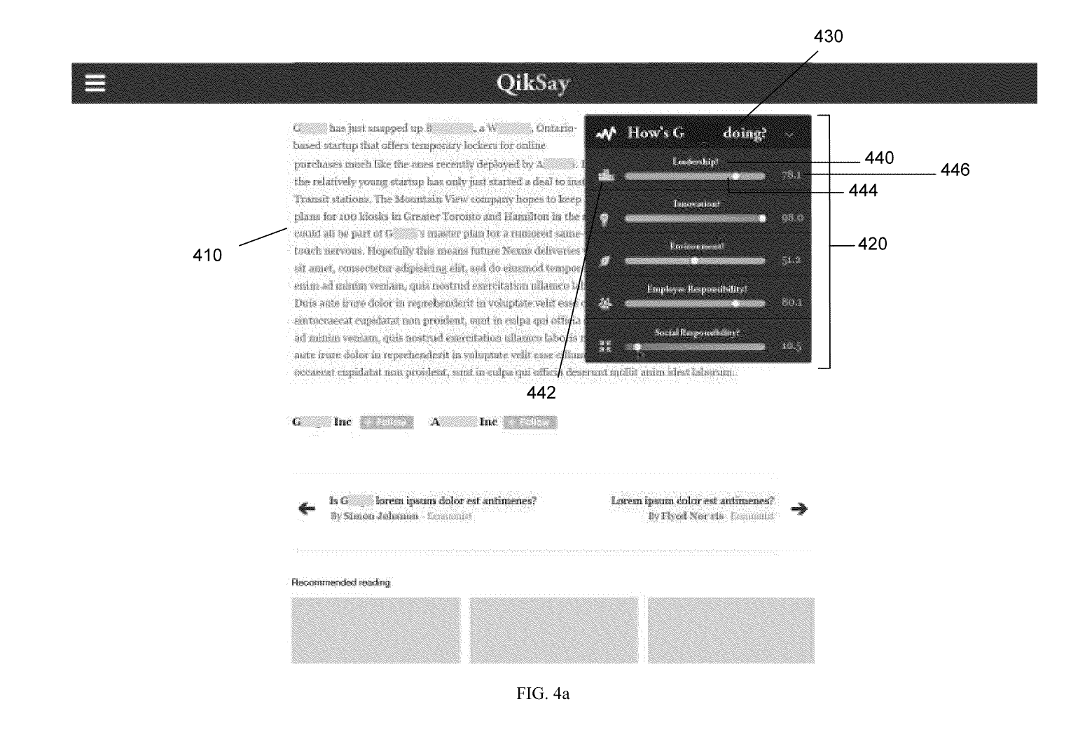

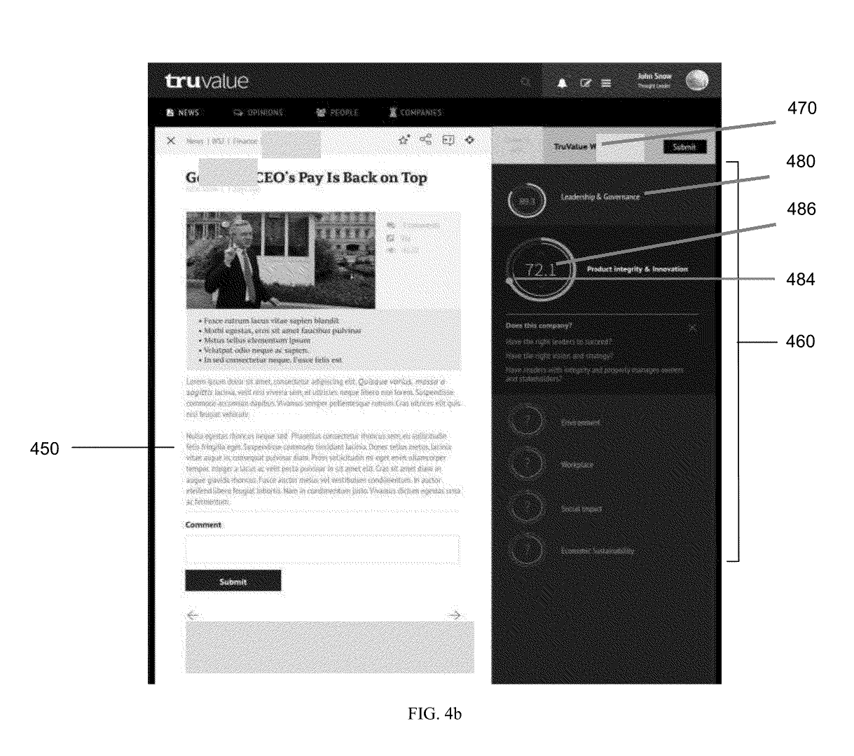

FIG. 4a and FIG. 4b shows examples of user interfaces through which an observer may provide feedback in response to one or more questions. Information 410, 450 about the entity may be displayed. A feedback region 420, 460 may be displayed through which the observer may provide feedback.

The feedback region 420, 460 may include a general query 430, 470. The general query may relate to the value of the entity. For example, the general query may ask how the entity is performing overall. Entity performance can be determined according to different categories or metrics. One or more specific queries 440, 480 may also be displayed. The specific queries may relate to one or more different categories or metrics relating to the general query. For example, if the general query asks how an entity is performing, the specific queries may relate to different areas or categories of how the entity is doing. For example, the specific categories may include leadership/governance, product innovation/integrity, environmental responsibility, employee responsibility/workplace, social responsibility/impact, and/or economic sustainability. In some instances, five distinct categories may be provided. In alternative embodiments, one, two, three, four, five, six, seven, eight, nine, ten, or more categories may be provided in order to assess entity value or performance.

In some instances, the feedback region 420, 460 may include a visual representation 442 of each category for the specific queries 440, 480. For example, the visual representation may be an icon or picture (or tool tip or helper text) representative of categories, such as leadership, innovation, environmental responsibility, employee responsibility, social responsibility and/or economic sustainability. Such visual representation may create a broader idea of specific category.

One or more interactive tool may be provided through which the observer may provide feedback. For example, as shown in FIG. 4a, a linear slider bar 444 may be provided through which the observer may select where the entity falls in the spectrum from each category. For example, the observer may select where along the spectrum of leadership, innovation, environment, employee responsibility, and/or social responsibility the entity falls, and may adjust the placement of the slider bar accordingly. In another example, as shown in FIG. 4b a circular slider bar 484 may be provided that may function in a similar manner to the linear slider bar. The circular loop may permit an observer to select where the entity falls in the spectrum from each category. The observer may select a position along the circumference of the loop correlating to where the entity falls within each category. The selected position may slide about the circumference of the loop. The slider bar (e.g., the linear slider bar, the circular slider bar) may be an example of a gradient feedback tool.

The interactive tool may permit the observer to easily and simply provide feedback. For example, the observer may provide feedback without having to type in any letters, words, or numbers. The observer may drag a visual indicator into a desired position, or click or touch a desired option. In an alternative to a slider bar, one or more options may be provided that the user may select. Such tools may make it easier to quickly allow an individual to express his or her opinion. An individual may express an opinion with a single click, touch, or drag.

In some instances, category values 446, 486 may be displayed in the feedback region. For example, each category may have a category value reflecting a numerical value for each category. The numeral value may correspond to the placement of the slider on the slider bar 444 or circular bar 484. For example, moving a slider along a linear slider bar 444 to the right may increase the numerical value, and moving the slider to the left may decrease the numerical value. The category value 446 may be provided in the same row or column as the linear slider bar and may be adjacent to the slider bar. In another example, moving a slider about a loop in a clockwise direction relative to a top position or other starting position in a circular bar 484 may increase the numerical value, and moving the slider value closer to the starting position may decrease the numerical value. The category value 486 may be positioned within the loop and/or may be circumscribed by the circular bar.

In one example, the numerical value for each category may fall between 0 and 100. The numerical value may be adjacent to the slider bar or within a circular bar. In one example, an entity, such as a company, may receive numerical scores for categories such as leadership, innovation, environment, employee responsibility, and social responsibility.

In some instances, the placement of the slider on the slider bar may also be associated with a color scheme, representing emotional attachment to the related category. For example, the color scheme may reach from red representing disagreement to green representing agreement. In some instances, red (or another selected color) may correspond to a lower numerical value while green (or another selected color) may correspond to a higher numerical value. A gradient of colors between the selected colors may be provided corresponding to slider position along the slider bar and/or numerical value scale.

In some instances, a default value may be provided on the gradient feedback tool 444, 484. For example, if the user does not provide any feedback, the value may default to midway on a slider bar or circular bar. The numerical category scores 446, 486 may correspondingly have a default value. For example, the numerical category score may default to 50 out of 100, or 5 out of 10, or any other value.

In some embodiments a feedback region 420, 460 may have an expanded form and a contracted form. For example, when the observer selects an option to provide feedback for the entity, the region may expand to display the various categories for which the observer may provide feedback. The feedback region may remain in the same user interface that simultaneously displays the information about the entity 410, 450.

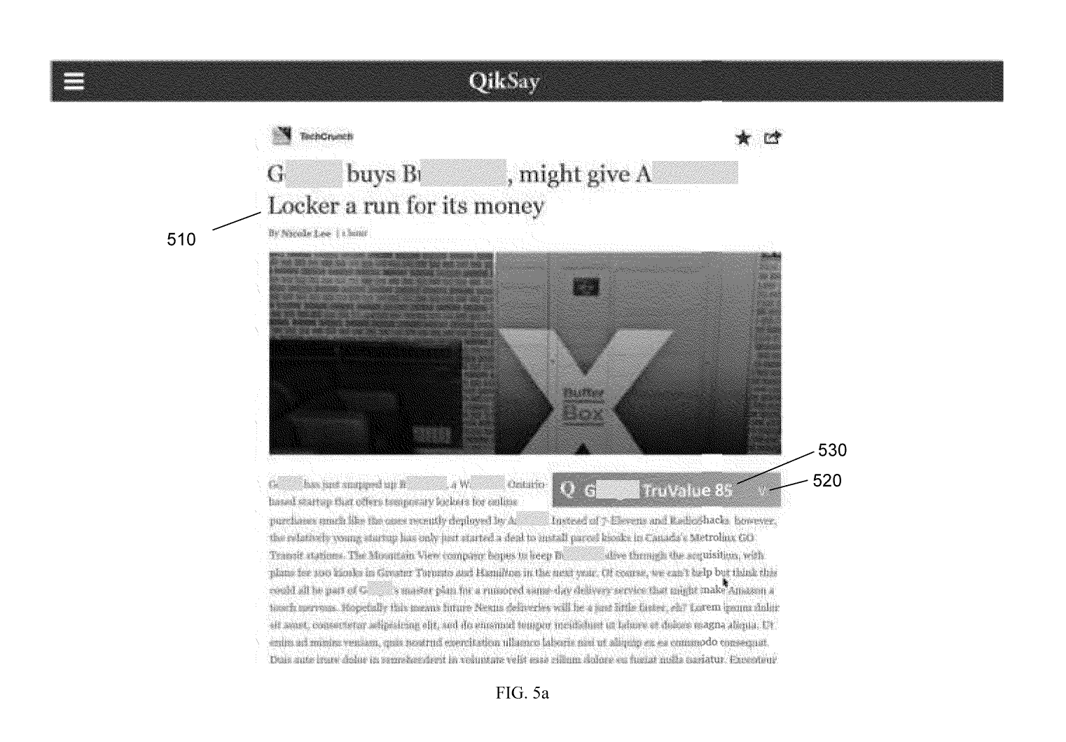

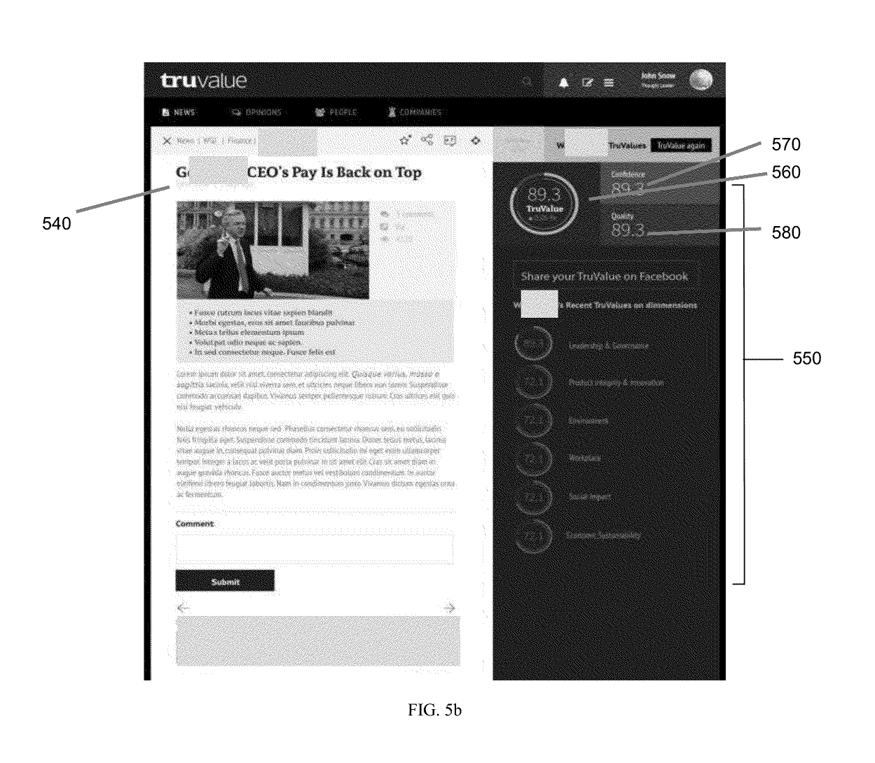

FIG. 5a and FIG. 5b show examples of user interfaces showing a score indicative of the value of the entity. The user interface may show information about the entity 510, 540 and a feedback region 520, 550. The feedback region may show the score, which may be a numerical score 530, 560 indicative of the overall value of the entity. As previously described, the value may relate to crowd-based sentiment, performance, financial value, or any other index. The score may be a crowd-based sentiment index for the entity overall. The score may reflect a ‘true value’ of the entity.

In some embodiments, the entity value score may be calculated using any of the systems and methods described elsewhere herein. In one example, the entity value score may incorporate category scores from one, two or more categories. For example, the entity value score may be calculated based on a leadership score, innovation score, environment score, employee responsibility score, social responsibility, and/or economic sustainability score for the entity. Other examples of categories may include supplier relations or corporate governance. The categories may be ESG categories. In some instances six or fewer, or five or fewer categories may be provided. In other instances, ten or fewer categories may be provided. The overall entity value score may be an average of the various category scores.

In some implementations, the overall entity value score may be a weighted average of the various category scores. For example, category score A may have a weight of 5, category score B may have a weight of 2, category score C may have a weight of 2, and category score D may have a weight of 1. The overall entity value score may be 5×(average category score A)+2×(average category score B)+2×(average category score C)+(average category score D). The weights may be selected based on one or more different characteristics (e.g., sector, company focus, industry, current buzz, or other areas). For example, category A may be deemed to be more relevant in certain industries, and may receive a higher weight. In another example, category A may be deemed to relate to a topic that has been receiving a large amount of press attention recently, and may receive a higher weight. The weights may be determined by an observer, administrator, or may be automatically generated with aid of a processor. The weights may be established in accordance with an algorithm with aid of the processor.

The various category scores may include scores inputted by the observer that is viewing the overall entity value score. The various category scores may incorporate scores inputted by other observers than the observer viewing the entity value score. The category scores may be updated in real-time, or with a high level of frequency. The overall entity value score may also be updated in real-time or with a high level of frequency. For example, the various scores may be updated every millisecond, every few milliseconds, every second, every few seconds, every half minute, every minute, every few minutes, every half hour, or every hour. The scores may be reflective of crowd-based sentiment and may be gathered from multiple observers. Multiple observers may provide feedback via a feedback region of their respective user interfaces. In some instances, the feedback from each of the observers may be weighted equally. Alternatively, observers with different backgrounds or qualifications may have their feedback weighted differently. For example, observers who are experts in a particular field may have their feedback relating to that field weighted higher than observers who are not experts.

In some embodiments, in addition to the numerical score 530, 560, the feedback region may have additional visual indicators of the entity true value. For example, if the entity score is in the higher range, a particular color may be displayed. If the entity is in a lower range, a different color may be displayed. Such visual indicators may make it easy for an observer to determine with a glance the overall determined value for the entity.

In some embodiments, a confidence 570 and/or quality 580 of for the numerical score 560 may be provided. The confidence and/or quality may be calculated using any of the techniques described elsewhere herein. Factors, such as moving averages, trends, trend confidence, observer concentration, freshness, long term sentiment, and/or other factors may be considered. Temporal aspects may be considered in determining the confidence and/or quality of the numerical score. For examples, changes over time, or the recentness of data may be considered. A confidence value 570 may be indicative of a confidence that a trend will continue. A higher numerical confidence value may correlate to a greater confidence that the trend will continue. A quality value 580 may be indicative of a concentration and/or freshness of observer input. A higher numerical quality value may correlate to greater concentration and/or freshness of observer input.

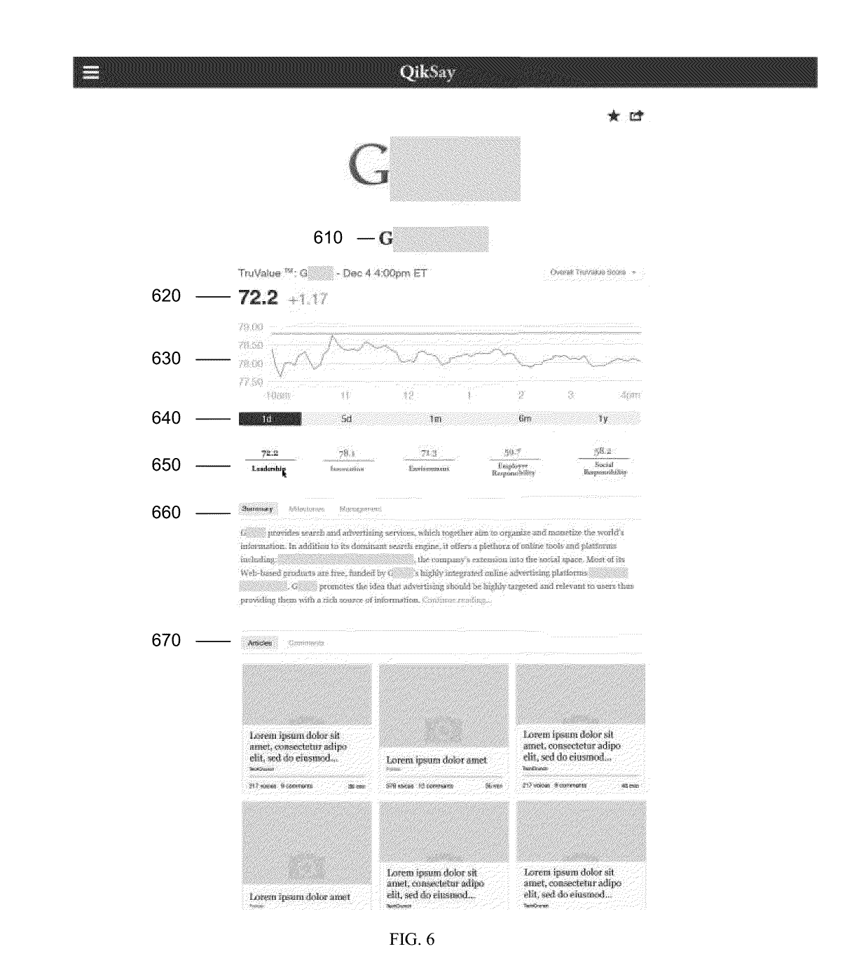

FIG. 6 shows a display providing information about an entity's overall value score as well as scores for specific categories. In some instances, information about an entity's value may be displayed in a user interface. The user interface may show an entity summary page.

The entity name 610 may be presented on the user interface. The entity's overall value score 620 may be displayed as a numerical value. In some instances, a stock market index value 630 for the entity may be displayed.

Information about the entity may be displayed over a window of time. A time selection option 640 may be provided through which an observer may be able to select a window of time from a plurality of options. For example, the windows of time may include 1 day, five days, 1 month, 6 months, or a year. The value and/or index information may be updated to reflect the selected time window.

The displays may accommodate differing scales of heterogeneous quantities, which may enable an observer to visually correlate relationships. For example, a stock price may be displayed simultaneously with a total and/or category score.

The user interface may also display various category scores 650 for the entity. For example, numerical values for different categories, such as leadership, innovation, environment, employee responsibility, and/or social responsibility may be displayed. The various category scores may be used in calculating the entity's overall value score 620. In some instances, an observer may be able to select a category score to receive additional information about the category or the entity's performance within the category.

In some embodiments, an observer, administrator, or other user may be able to specify which categories to use to specify the overall value score. The overall value score may be personalized to an individual user's needs or desires. For example, if a user does not believe that an innovation score should be a factor of the overall value score, then the user can have the overall value score calculated without factoring in innovation. The user may select one or more categories from a predetermined list of categories. Alternatively, a user may be able to submit a category of the user's own. The categories may be dynamically updated or customized. The user may or may not specify any weighting of the categories in generating the overall value score.

Additional information 660 about the entity may be displayed on the user interface. The additional information may include a summary of the entity, milestones, or information about management of the entity.

In some instances, articles 670 about the entity or comments relating to the entity may be displayed. The articles may include visual information, a title of the article, the source of the article, and various feedback information.

Browser Extension Tool

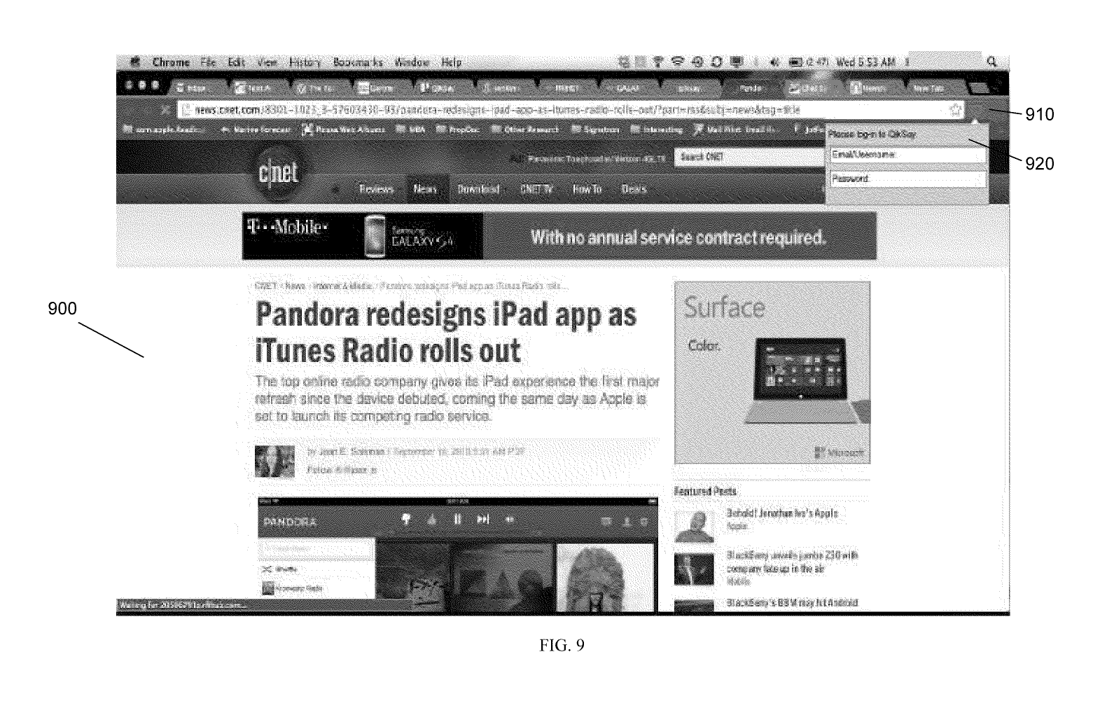

FIG. 9 shows an example of a browser extension tool that may be used to collect user feedback about a web site. The browser extension tool may provide feedback from any website. For instance, the website may be the website of an entity that provides crowd-based sentiment indices or may be a website of a different entity. The browser plug-in can be directly installed in the browser bar (e.g., Safari, Firefox, Explorer, Chrome) and can pull up a voting widget on a button press. This may permit a user to provide feedback anywhere on the Internet. The score, along with the content source of the website, may be submitted to an entity (and/or server thereof) that provides crowd-based sentiment indices. The feedback may be incorporated into an overall index for the source and/or content.

A website 900 may be displayed on a user interface with aid of a browser. A visual representation of the browser extension tool 910 may be provided on the browser environment. Selecting the browser extension tool may provide an option for a user to log in. An authentication interface 920 may be provided for a user to provide the user's identifier (e.g., email, username) and/or password. Alternatively, a user may be pre-logged in, or may not need to be authenticated to access to the browser extension tool.

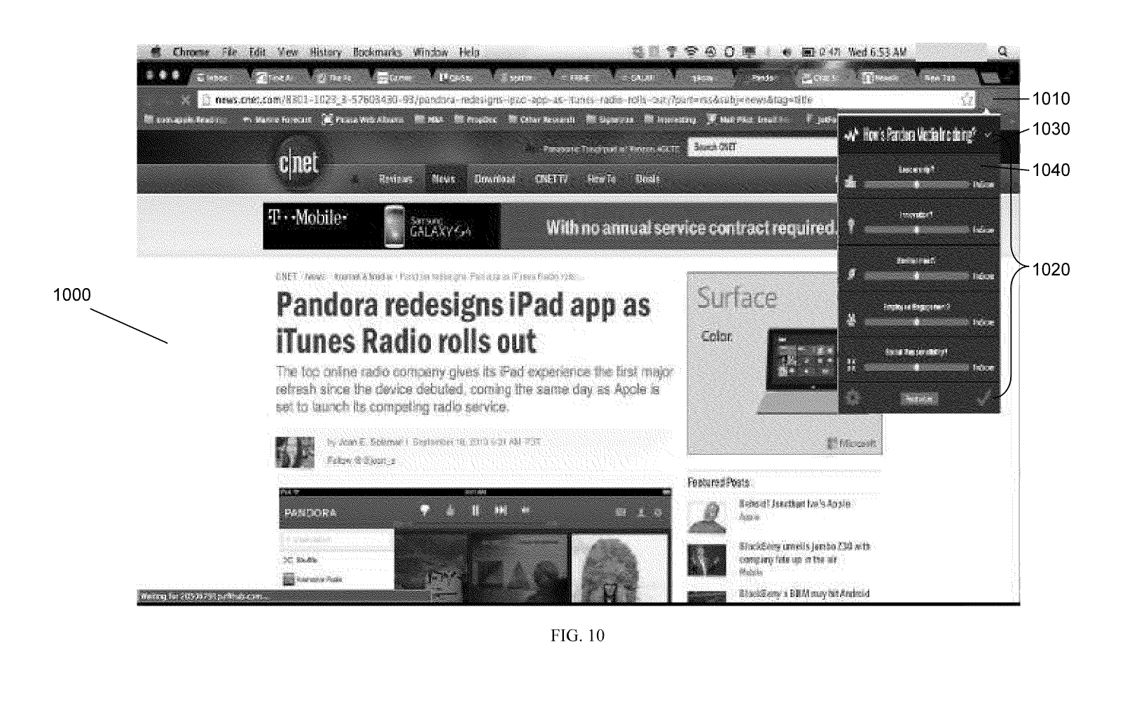

FIG. 10 shows an example of a feedback region implemented using a browser extension tool. Selecting a browser extension tool 1010 may result in a feedback region 1020 being displayed. The feedback region may have one or more characteristics described elsewhere herein. The feedback region may include a general query 1030 and/or one or more specific queries 1040. A user may be able to provide a feedback about the specific queries via the user interface.

In some instances, the feedback region 1020 may overlie a website 1000. In some instances, the website may provide content about an entity. The feedback region may include queries about the entity and/or entity performance. The queries in the feedback region may relate to the content of the website, which may be about the entity, or any other types of content as described elsewhere herein.

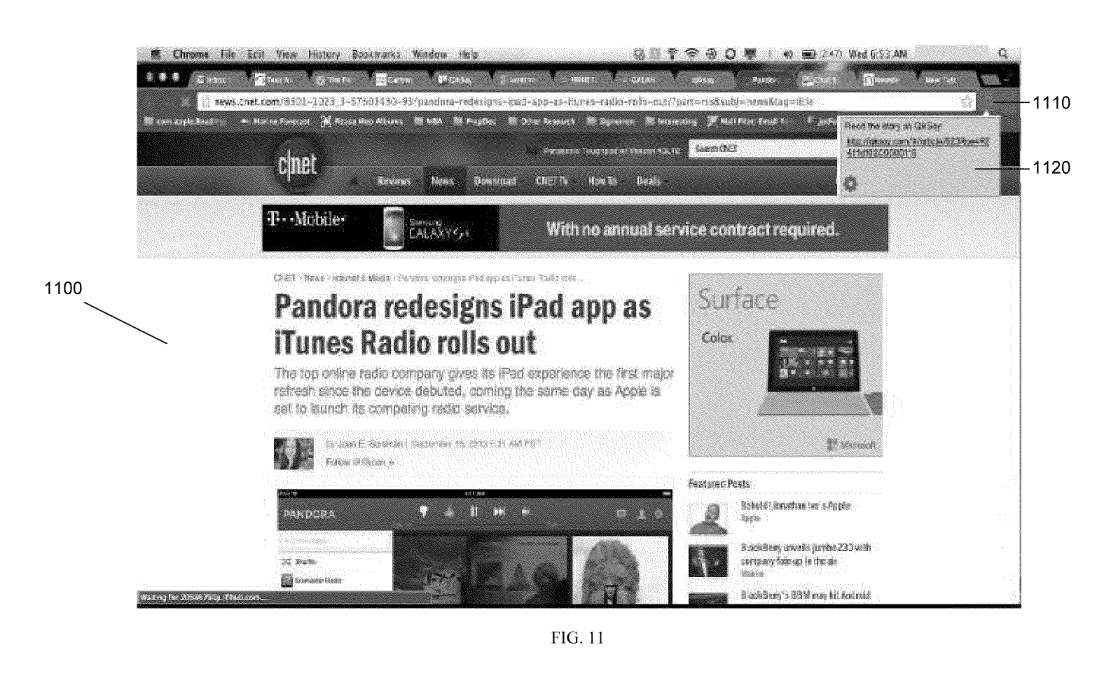

FIG. 11 shows an example of a browser extension tool providing a link to a website of a system for providing crowd-based sentiment indices. For example a website 1100 may be displayed in a browser. A browser extension tool 1110 may be provided through which a user may provide feedback relating to content of the website. In some instances, the browser extension tool may provide a link 1120 to another website through which a user may get more information relating to the content of the web site. The other website may be a website of a party that calculates and/or provides crowd-based sentiment indices. If the content of the website 1100 relates to an entity, the other website may provide additional information about the entity, such as an overall value score of the entity, category scores for the entity, financial information relating to the entity, articles relating to the entity, or any other information, including information described elsewhere herein.

Tools and Widgets

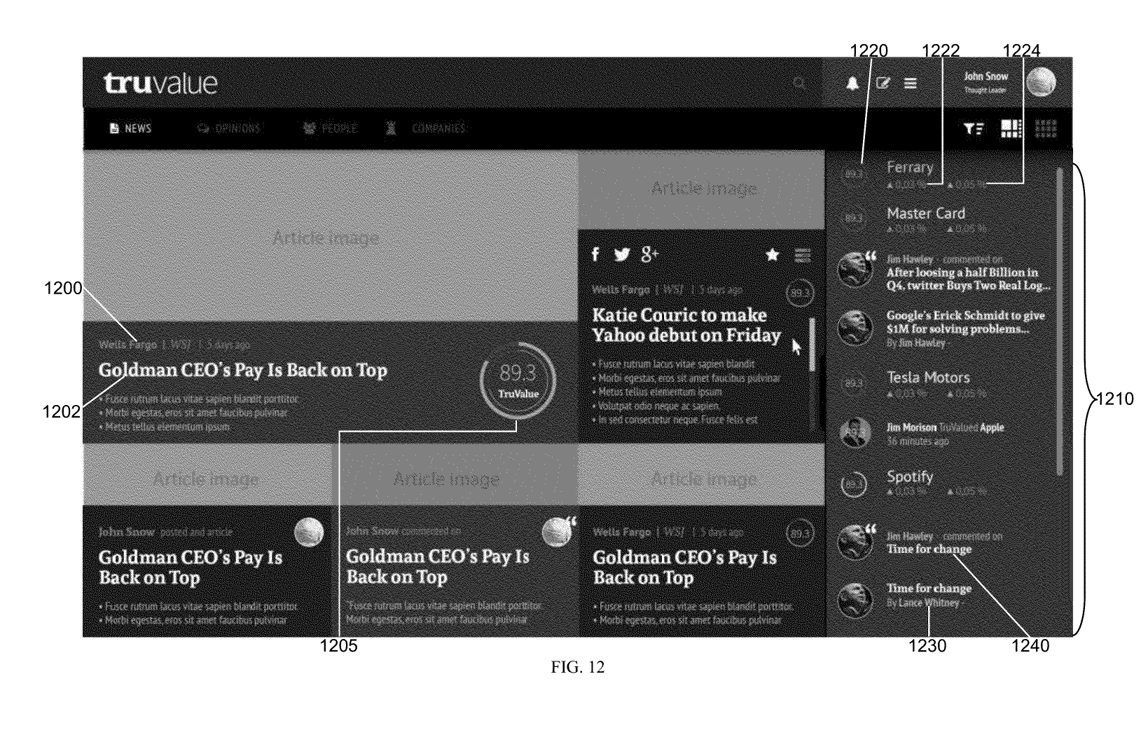

FIG. 12 shows an example of a user interface that displays live updates. General information and/or articles may be displayed 1200. In some instances, the articles may be about one or more companies 1202. The overall value score 1205 for the company may be displayed. In some instances, whenever an article names a company in its headline, an overall value score for the named company may be displayed. The overall value score may be reflective of scores given by multiple users. For example, the overall value score may be a crowd-based sentiment index. In other examples, the overall value score displayed may be reflective of a score provided by a user that is viewing the article.

A live update region 1210 may be displayed. The live update region may be on the left hand side, right hand side, top portion, or bottom portion of the user interface. The live update region may be updated periodically or in real time. The live updates may include information about various companies. For example, the overall value score 1220 of the company may be displayed. Changes to the overall value score of the company may be displayed. The changes may be displayed as numerical score changes 1222 and/or relative percent changes 1224. A visual indicator may be provided whether the changes are positive or negative. The information may scroll through and may be indicative of changes within a given period of time, such as those described elsewhere herein. The changes may reflect real-time changes and/or values.

Other information relating to the companies may be displayed. For example, the appearance of new articles 1230 may be provided. Comments 1240 by other users or individuals to the articles or relating to the company may also be provided. The appearance of the new information may be updated in real time.

The live update region 1210 may be provided so that newer information provided on top or in the front, and older information would scroll downwards or toward the back. As new information is provided, the new information may displace the older information, which may move further down or backwards.

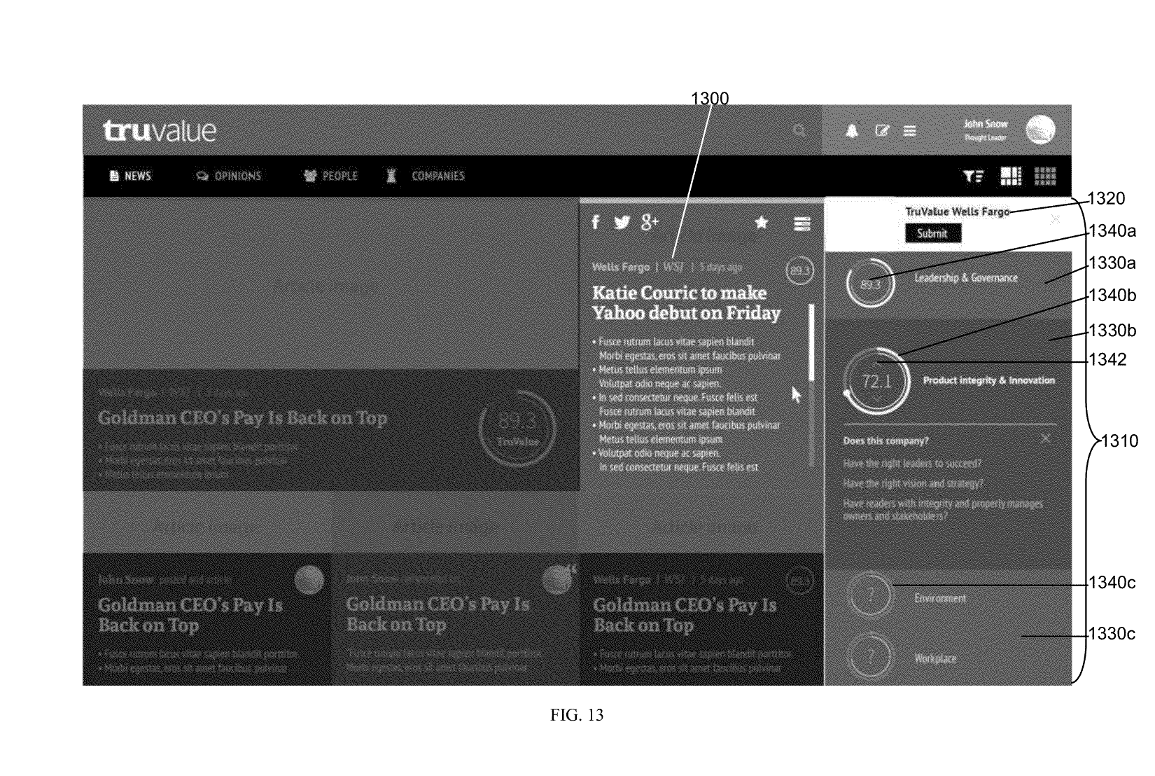

FIG. 13 shows an example of a voting widget. A selected article about a company 1300 or any other type of information relating to a company may be provided. Selecting a company (e.g., by selecting an article about the company) may cause a voting widget 1310 to be displayed. The voting widget may be displayed in any region of the user interface (e.g., left side, right side, top side, bottom side).

The voting widget 1310 may show the company name 1320. One or more categories 1330a, 1330b, 1330c for evaluation may be provided. Examples of such categories may include, but are not limited to, leadership & governance, product integrity & innovation, environment, workplace, social impact, and/or economic sustainability. When a user has already rated a company in a particular category 1330a the user's category score 1340a for the company may be displayed. When a user is in the process of rating a company in a particular category 1330b, the user's category score 1340b may be displayed once the user has entered a value. Optionally a default value may be provided. An expanded view may be provided which may include information or criteria for the user to consider when rating the company. When a user has not yet rated a company in a particular category 1330c, no category score 1340c may be presented. In some instances, a question mark or similar information indicating the category has not yet been rated may be provided.

When a user is rating a company category, a gradient tool, such as a circular bar 1340b may be provided. The user may slide a slider along the circular bar, or any other type of gradient tool. The numerical value may be updated to reflect the position of the slider along the gradient tool. In some examples, arrows 1342 or similar tools may be provided through which the user may manipulate the numerical value directly.

When the user has entered the user's feedback for the various categories, the overall score for the company provided by the user may be shown or displayed. This overall score may be considered in conjunction with overall scores provided by other users to provide a crowd-based sentiment index.

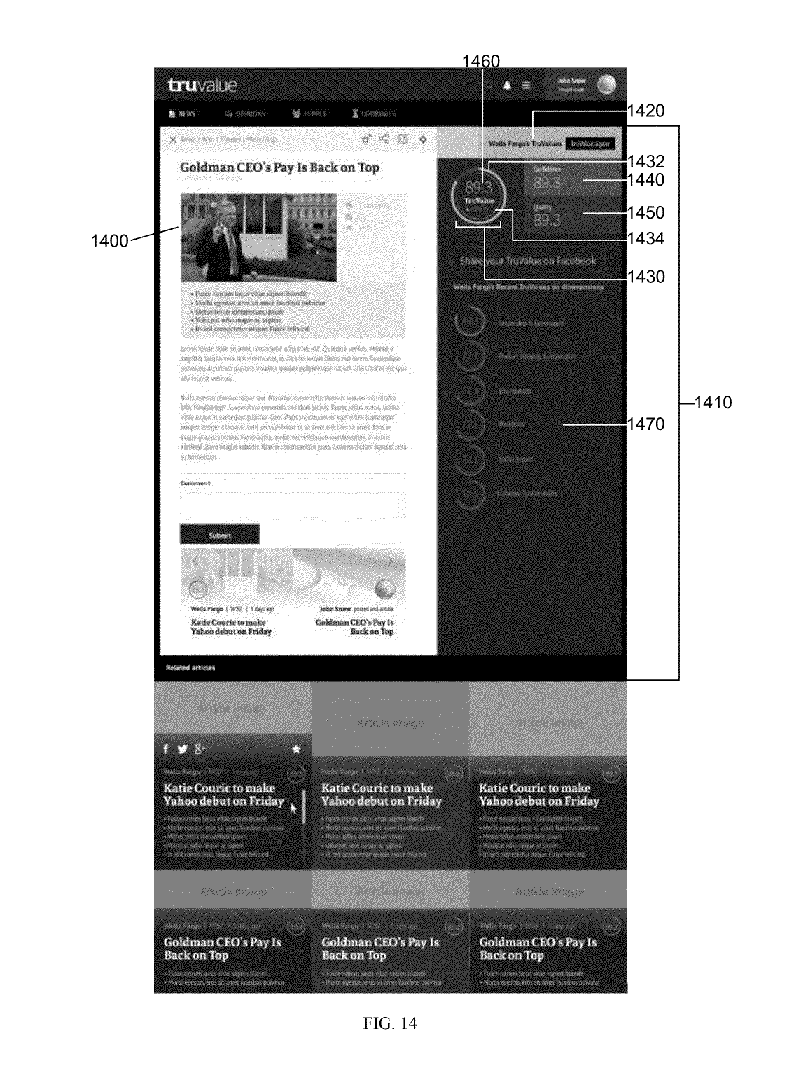

FIG. 14 shows another view of a voting widget 1410 in accordance with an embodiment of the invention. The voting widget may be tied to a company for which information may be displayed 1400. In some instances, the information may be an article about the company.

The voting widget may show the company name 1420. The voting widget may show an overall score for the company 1430. In some embodiments, a confidence 1440 and/or quality value 1450 may also be provided. The overall score may include a double gradient indicator. For example, a double ring voting circle may be shown. An outer ring 1432 may show a current score provided by the user and an inner ring 1434 may show an existing value (e.g., overall value from the combined feedback of other users), or vice versa. The numerical value 1460 displayed for the overall score may be reflective of the current score provided by the outer ring, or the existing value provided by the inner ring. Optionally, comparison value 1465, such as a percent change may be displayed. The percent change may be for the current score relative to the existing value.

The voting widget may show one or more categories 1470. Each of the categories may be representative of a dimension along which the company may be evaluated in determining the overall score. The dimensions may be ESG categories. The overall score may be an ESG rating for the company. The categories may show a score for each of the categories. In some embodiments, each of the category scores may be a double gradient indicator. For example, a double ring may be provided showing the current score for each category as compared to the existing score for the category. Numerical values may also be displayed, which may be reflective of the current category score or the existing category score. A user may be able to manipulate the ring that shows the current score without being able to manipulate the existing score. In some instances, a user may be able to manipulate a slider an on outer ring without being able to manipulate data on an inner ring. The double ring, or double gradient indicator may advantageously provide a simple visual interface through which a user may view how the user's scoring of the company compares to existing scores for the company.

Ticker

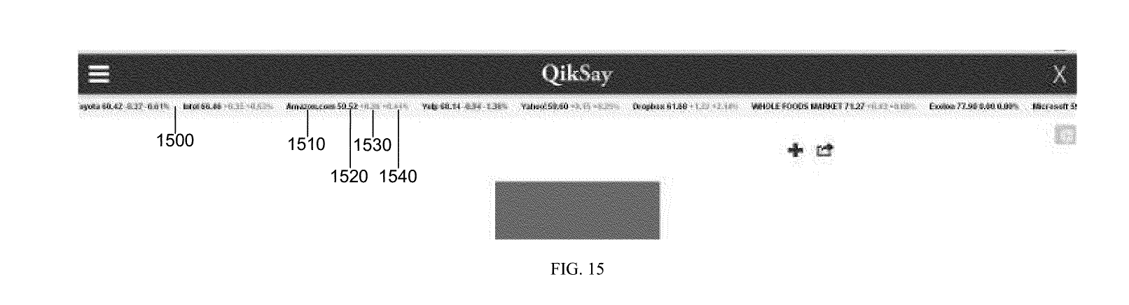

FIG. 15 shows an example of a ticker display 1500 in accordance with an embodiment of the invention. The ticker display may have a format similar to that as applied to stock and other financial data, and may be utilized for displaying real-time changes in sentiment indices.

In some embodiments, the ticker display may show a company name 1510, as well as an overall value score 1520 for the company. The overall value score may be a numerical value. In some instances, the numerical value may fall between 0 and 100 or between any other two numbers. Optionally, changes 1530 in the overall value score may be displayed. The changes in the overall value score may be a numerical change over a period of time. In some examples, the period of time may be since the previous day. Other examples of time periods may include years, 1 year, quarters, months, 1 month, weeks, 1 week, days, 1 day, hours, 1 hour, 30 minutes, 10 minutes, or 1 minute. The relative changes 1540 in the overall value score may also be displayed. The relative change may be displayed as a percentage value. The percentage change may be the difference between the current overall value and the previous overall value divided by the previous overall value (or alternatively divided by the current overall value). The previous overall value may be the overall value score at the previous period of time.

The changes 1530 and/or relative changes 1540 in the overall score may show whether a positive or negative value change has occurred.

The ticker display may be shown as part of a web site or other environment. The ticker may include the company names and related information scrolling. The information may scroll across horizontally or vertically. For instance, an entity name and overall value score for multiple entities may scroll in a linear fashion.

System

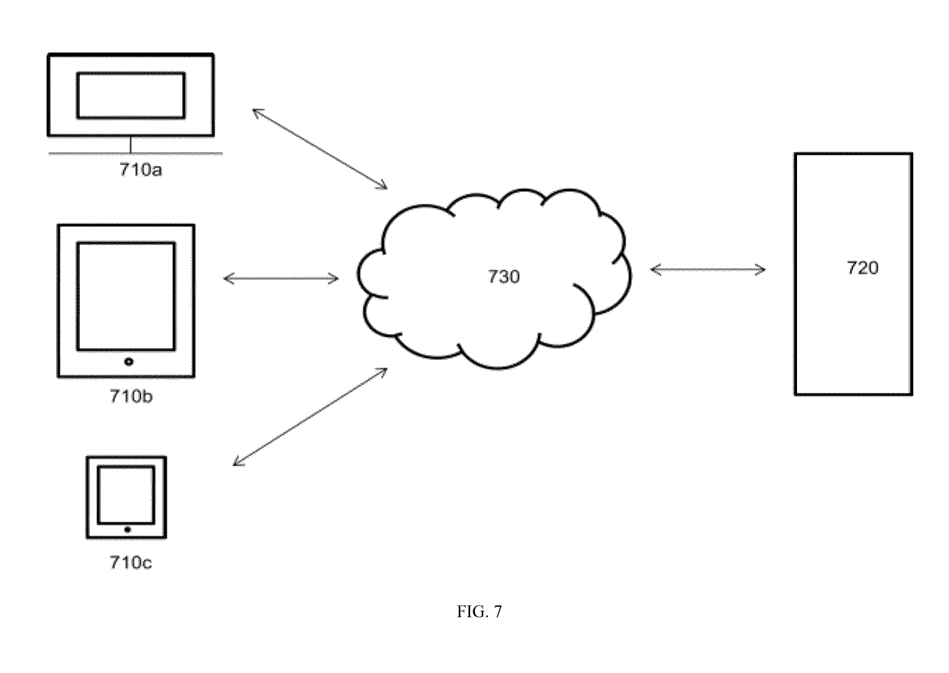

FIG. 7 shows a system for providing crowd-based sentiment indices in accordance with an embodiment of the invention.

One or more devices 710a, 710b, 710c may be in communication with one or more servers 720 of the system over a network 730.

One or more user may be capable of interacting with the system via a device 710a, 710b, 710c. In some embodiments, the user may be an observer or contributor that may provide feedback relating to an entity, such as a company. The user may be an individual viewing information about the entity, such as a value for the company. In some instances, the user may be an investor or broker.

The device may be a computer 710a, server, laptop, or mobile device (e.g., tablet 710c, smartphone 710b, cell phone, personal digital assistant) or any other type of device. The device may be desktop device, laptop device, or a handheld device. The device may be a networked device. Any combination of devices may communicate within the system. The device may have a memory, processor, and/or display. The memory may be capable of storing persistent and/or transient data. One or more databases may be employed. Persistent and/or transient data may be stored in the cloud. Non-transitory computer readable media containing code, logic, or instructions for one or more steps described herein may be stored in memory. The processor may be capable of carrying out one or more steps described herein. For example, the processor may be capable of carrying out one or more steps in accordance with the non-transitory computer readable media.

A display may show data and/or permit user interaction. For example, the display may include a screen, such as a touchscreen, through which the user may be able to view content, such as a user interface for providing information about an entity or soliciting feedback about the entity. The user may be able to view a browser or application on the display. The browser or application may provide access to information relating to an entity. The user may be able to view entity information via the display. The display may be capable of displaying images (e.g., still or video), or text. The display may be a visual display that shows the user interfaces as described elsewhere herein. The display may emit or reflect light. The device may be capable of providing audio content.

The device may receive user input via any user input device. Examples of user input devices may include, but are not limited to, mouse, keyboard, joystick, trackball, touchpad, touchscreen, microphone, camera, motion sensor, optical sensor, or infrared sensor. A user may provide an input via a tactile interface. For instance, the user may touch or move an object in order to provide input. In other instances, the user may provide input verbally (e.g., speaking or humming) or via gesture or facial recognition.

The device may include a clock or other time-keeping device on-board. The time-keeping device may be capable of detecting times at which user inputs are made. In some instances, the device may generate a timestamp associated with the user inputs that may be useful for calculating one or more score as described elsewhere herein. The timestamps may be associated with user feedback and useful for determining feedback to include in specified timeframes.

The device 710a, 710b, 710c may be capable of communicating with a server 720. The device may have a communication unit that may permit communications with external devices. Any description of a server may apply to one or more servers and/or databases which may store and/or access content and/or analysis of content. The server may be able to store and/or access crowd-based sentiment relating to one or more entities. The one or more servers may include a memory and/or programmable processor.

A plurality of devices may communicate with the one or more servers. Such communications may be serial and/or simultaneous. For examples, many individuals may participate in viewing information about an entity and/or providing feedback relating to an entity. The individuals may be able to interact with one another or may be isolated from one another. In some embodiments, a first individual on a first device 710a may provide feedback relating to an entity, which may affect the entity scores which may be viewed by the first individual and a second individual on a second device 710b. In some embodiments, both the first individual and the second individual may provide feedback about an entity which may be used as at least part of the basis of the entity score calculations which may be viewed by the first individual and/or second individual.

The server may store information about entities. For example, feedback received relating to various entities may be stored. Entity scores relating to various categories/metrics or overall entity scores may be stored in memory accessible by the server. Information about users may also be stored. For example, information such as the user's name, contact information (e.g., physical address, email address, telephone number, instant messaging handle), educational information, work information, experience or expertise in one or more category or areas of interest, or other information may be stored.

The programmable processor of the server may execute one or more steps as provided therein. Any actions or steps described herein may be performed with the aid of a programmable processor. Human intervention may not be required in automated steps. The programmable processor may be useful for calculating and/or updating entity scores. The server may also include memory comprising non-transitory computer readable media with code, logic, instructions for executing one or more of the steps provided herein. For example, the server(s) may be utilized to calculate scores for entities based on feedback provided by users. The server may permit a user to provide feedback via a user interface, such as a widget.

The device 710a, 710b, 710c may communicate with the server 720 via a network 730, such as a wide area network (e.g., the Internet), a local area network, or telecommunications network (e.g., cellular phone network or data network). Communication may also be intermediated by a third party.

In one example, a user may be interacting with the server via an application or website. For example, a browser may be displayed on the user's device. For example, the user may be viewing a user interface for entity information via the user's device.

Aspects of the systems and methods provided herein, such as the devices 710a, 710b, 1710c or the server 720, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

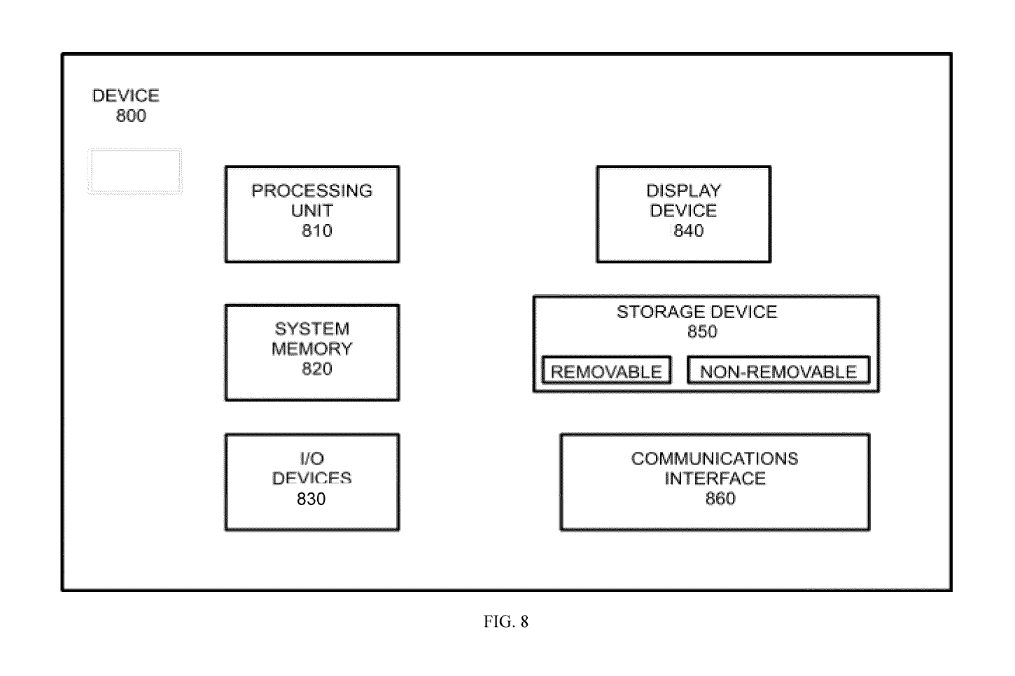

FIG. 8 shows an example of a computing device 800 in accordance with an embodiment of the invention. The device may have one or more processing unit 810 capable of executing one or more step described herein. The processing unit may be a programmable processor. The processor may execute computer readable instructions. A system memory 820 may also be provided. A storage device 850 may also be provided. The system memory and/or storage device may store data. In some instances the system memory and/or storage device may store non-transitory computer readable media. A storage device may include removable and/or non-removable memory.

An input/output device 830 may be provided. In one example, a user interactive device, such as those described elsewhere herein may be provided. A user may interact with the device via the input/output device. A user may be able to provide feedback about an entity using the user interactive device.

In some embodiments, the computing device may include a display 840. The display may include a screen. The screen may or may not be a touch-sensitive screen. In some instances, the display may be a capacitive or resistive touch display, or a head-mountable display. The display may show a user interface, such as a graphical user interface (GUI), such as those described elsewhere herein. A user may be able to view information about an entity, such as overall value score for the entity or category scores for the entity through the user interface. In some instances the user interface may be a web-based user interface. In some instances, the user interface may be implemented as a mobile application.

A communication interface 860 may also be provided for a device. For example, a device may communicate with another device. The device may communicate directly with another device or over a network. In some instances, the device may communicate with a server over a network. The communication device may permit the device to communicate with external devices.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method of providing a crowd sentiment-based index for an entity, comprising:
displaying, on a visual display of a device, information about the entity;
receiving, via the device, feedback from a user of the device providing an evaluation of the entity in a plurality of categories, wherein the categories include two or more of the following: leadership, innovation, environment, employee responsibility, and social responsibility; and
calculating, with aid of a programmable processor, an overall entity value score based on the feedback from the user regarding the plurality of categories, thereby assessing social sentiment for the entity.

2. The method of claim 1, wherein the categories include three or more of the following: leadership, innovation, environment, employee responsibility, and social responsibility.

3. The method of claim 1, further comprising displaying, on the visual display of the device, the overall entity value score with information about the entity.

4. The method of claim 1, wherein the information about the entity includes a news article about the entity.

5. The method of claim 1, wherein the feedback from the user is provided via a user input region for each of the plurality of categories shown on the visual display with the information about the entity.

6. The method of claim 5, wherein the user input region includes a sliding scale, and wherein the user selects a position along the sliding scale indicative of a numeral score for a respective category from the plurality of categories.

7. The method of claim 6, wherein the sliding scale has a substantially circular shape.

8. The method of claim 1, wherein the overall entity score is calculated with aid of the programmable processor, further based on feedback from other users regarding the plurality of categories.

9. The method of claim 8, wherein a trend confidence in the overall entity score is displayed with the overall entity score on the visual display of the device.

10. The method of claim 9, wherein the trend confidence is displayed as a numerical confidence value calculated using a root mean square error technique.

11. The method of claim 8, wherein a crowd strength data quality is displayed with the overall entity score on the visual display of the device.

12. The method of claim 11, wherein the crowd strength data quality is displayed as a numerical quality value calculated with aid of the programmable processor, based on a start time and a stop time for consideration of feedback from the user and the other users between the start time and the stop time, and a freshness decay calculation of the feedback from the user and the other users used to calculate the overall entity score.

13. The method of claim 8, wherein the overall entity score includes a numerical value and a double gradient indicator having a first portion and a second portion, wherein the first portion shows a visual indication of an overall entity score based on the feedback from the user without considering feedback from the other users and the second portion shows a visual indication of an overall entity score based on feedback from the user and the other users.

14. A method of providing a crowd sentiment-based index for an entity, comprising:
displaying, on a visual display of a device, an overall entity value score for the entity calculated based on feedback from a plurality of users, each user providing an evaluation of the entity in a plurality of categories, wherein the categories include two or more of the following: leadership, innovation, environment, employee responsibility, and social responsibility; and
displaying information identifying the entity on the visual display with the overall entity value score.

15. The method of claim 14, wherein the visual display of the device shows a plurality of entity identifiers and associated overall entity value scores for each of the entity identifiers.

16. The method of claim 15, wherein the visual display further shows a numerical amount of change in the value of the overall entity score for each of the entity identifiers.

17. The method of claim 16, wherein the visual display shows a ticker display that shows the plurality entity identifiers scrolling in a linear fashion along with the associated overall entity value scores and the numerical amount of change.

18. The method of claim 14, wherein the visual display of the device shows a news article about the entity including the information identifying the entity.

19. The method of claim 14, wherein the visual display shows a percentage change in the value of the overall entity score.

20. The method of claim 14, wherein the visual display shows category evaluations for the entity in the plurality of categories, wherein the category evaluations are based on feedback from the plurality of users.
